(19) United States
(12) Patent Application Publication
(10) Pub. No.: US 2022/0357642 A1
(43) Pub. Date: Nov. 10, 2022

(54) DISPLAY APPARATUS AND PROJECTION SYSTEM

(71) Applicant: SONY GROUP CORPORATION, TOKYO (JP)

(72) Inventors: AKIRA AKIBA, TOKYO (JP); AKIHITO NISHIIKE, TOKYO (JP); SHINICHIRO TAJIRI, TOKYO (JP); ATSUHIRO CHIBA, TOKYO (JP)

(21) Appl. No.: 17/624,073

(22) PCT Filed: May 7, 2020
(86) PCT No.: PCT/JP2020/018484

§ 371 Date: Dec. 30, 2021

(30) Foreign Application Priority Data
Jul. 10, 2019 (JP) 2019-128266

(51) Int. Cl. G03B 21/20; G02B 26/02; H04N 9/31

(52) U.S. Cl. CPC G03B 21/2053; G03B 21/204; G02B 26/023; H04N 9/3155; H04N 9/3164

(57) ABSTRACT

A display apparatus of the present disclosure includes: a first optical system that generates illumination light whose light emitting luminance is variable; a light modulation unit that transmits the illumination light from the first optical system and whose transmissivity is variable; a second optical system that includes a light modulation device and optically modulates the illumination light from the first optical system by using a pulse width modulation technology, the illumination light having passed through the light modulation unit; and a control unit that controls the light emitting luminance of the illumination light from the first optical system and the transmissivity of the light modulation unit in any combination.

### TECHNICAL FIELD

The present disclosure relates to a display apparatus and a projection system.

### BACKGROUND ART

There have been proposed projectors (projection systems), each of which can easily modify a part of appearance of a projected image (for example, refer to Patent Document 1). It is described in Patent Document 1 (in particular, in paragraph [0032]) that instead of the liquid crystal panel, a digital mirror device (DMD) or the like may be used.

A micromirror is an on-state/off-state binary display device (light modulation device/light modulator).

In a case of the on-state/off-state binary display device (hereinafter, which may be referred to as an “on/off binary display device”), brightness of colors is controlled by using a pulse width modulation (PWM) technology. In addition, by combining the PWM technology with the well-known light modulation technology, a dynamic range (range of brightness) can be controlled without changing linearity of the whole PWM.

### CITATION LIST

### Patent Document

Patent Document 1: Japanese Patent Application Laid-Open No. 2015-176048

### SUMMARY OF THE INVENTION

### Problems to be Solved by the Invention

Incidentally, although in order to realize gradation expression which looks natural for a person's eyes, it is required to modify a gamma characteristic, in a case where the light modulation device is the on/off binary display device, the device cannot singly realize the gradation expression accompanied by gamma correction. Because of a characteristic of physical limitation in that in principle, a value of gradation display of the on/off binary display device is a discrete value from power-of-two values, gradations which can be optically outputted are optically linear. However, since a person's luminosity factor expresses non-linear gradations, physically linear gradations outputted by the above-mentioned video system are perceived by a person's eyes as non-linear and unnatural gradations. Although in order for natural and linear gradations to be perceived by a person, it is required to realize non-linear gradation expression (a gamma characteristic/a gamma curve) on an optical device side, the binary light modulation device cannot realize such gradation expression.

Objects of the present disclosure are to provide a display apparatus which can realize non-linear gradation expression (a gamma characteristic/a gamma curve) which is required of a video system even in a case where a light modulation device is an on/off binary display device and a projection system which uses the above-mentioned display apparatus.

### Solutions to Problems

A display apparatus of the present disclosure for achieving the above-described object includes:

a first optical system that generates illumination light whose light emitting luminance is variable;

a light modulation unit that transmits the illumination light from the first optical system and whose transmissivity is variable;

a second optical system that includes a light modulation device and optically modulates the illumination light from the first optical system by using a pulse width modulation technology, the illumination light having passed through the light modulation unit; and

a control unit that controls the light emitting luminance of the illumination light from the first optical system and the transmissivity of the light modulation unit in any combination.

In addition, a projection system of the present disclosure for achieving the above-described object includes:

a first optical system that generates illumination light whose light emitting luminance is variable;

a light modulation unit that transmits the illumination light from the first optical system and whose transmissivity is variable;

a second optical system that includes a light modulation device and optically modulates the illumination light from the first optical system by using a pulse width modulation technology, the illumination light having passed through the light modulation unit;

a projection optical system that projects light having passed through the second optical system; and

a control unit that controls the light emitting luminance of the illumination light from the first optical system and the transmissivity of the light modulation unit in any combination.

### BRIEF DESCRIPTION OF DRAWINGS

FIG. 1 is a system configuration diagram illustrating one example of a basic system configuration of a projection system.

FIG. 2 is a diagram showing relationship of combinations of illumination sequences and each opening of a diaphragm of a light modulation unit by a PWM technology of a driving example according to the conventional technology.

FIG. 3 is a linear characteristic diagram in a case where a binary light modulation device and a light modulation technology are simply linearly connected.

FIG. 4 is a block diagram illustrating a basic configuration of a display apparatus according to an embodiment of the present disclosure.

FIG. 5 is a diagram showing one example of relationship of combinations of illumination sequences and each opening of a diaphragm of a light modulation unit by a PAM technology+a PWM technology of a display apparatus according to the embodiment of the present disclosure.

FIG. 6 is a diagram showing driving results by the PAM technology +the PWM technology.

FIG. 7 is a block diagram illustrating a configuration of a display apparatus according to an embodiment 1.

FIG. 8A is a conceptual diagram showing a configuration of a solid-state light source according to an embodiment 2, and FIG. 8B is a diagram showing combinations of light emission of the solid-state light source according to the embodiment 2.

FIG. 9 is a bit sequence diagram showing a basic principle (simple color) of 4-bit grayscale according to the embodiment 2.

FIG. 10A is a conceptual diagram showing a configuration of a solid-state light source according to an embodiment 3, and FIG. 10B is a diagram showing combinations of light emission of the solid-state light source according to the embodiment 3.

FIG. 11 is a bit sequence diagram showing a basic principle (simple color) of 4-bit grayscale according to the embodiment 3.

FIG. 12 is a block diagram illustrating a configuration of a display apparatus according to an embodiment 4.

FIG. 13 is a block diagram illustrating a configuration of a display apparatus according to an embodiment 5.

FIG. 14 is a bit sequence diagram showing a basic principle (simple color) of 4-bit grayscale according to an embodiment 6.

FIG. 15A is a characteristic diagram of current-light emitting luminance in a case where lengths of light emitting time as to all bits are the same as one another, and FIG. 15B is a characteristic diagram of current-light emitting luminance in a case where lengths of light emitting time as to an LSB are made shorter than lengths of light emitting time as to the other bits.

FIG. 16 is a timing waveform diagram in a case of control according to an embodiment 7.

FIG. 17 is a diagram showing an example of a design method of a look-up table according to an embodiment 8.

FIG. 18 is a diagram showing a driving result of a technology according to the embodiment 8 in a case where a video source is a movie.

FIG. 19 is a diagram showing a driving result of the technology according to the embodiment 8 in a case where the video source is a sport.

FIG. 20 is a diagram showing a driving result of the technology according to the embodiment 8 in a case where the video source is an animation.

FIG. 21 is a diagram showing one example of order of bit sequences according to an embodiment 9.

FIG. 22 is a system configuration diagram illustrating one example of a configuration of a MEMS mirror type projection system according to an embodiment 10.

FIG. 23 is a system configuration diagram illustrating one example of a configuration of a MEMS mirror type projection system according to an embodiment 11.

FIG. 24 is a system configuration diagram illustrating one example of a configuration of a MEMS mirror type projection system according to an embodiment 12.

FIG. 25 is a system configuration diagram illustrating one example of a configuration of a MEMS mirror type projection system according to an embodiment 13.

FIG. 26 is a system configuration diagram illustrating one example of a configuration of a MEMS mirror type projection system according to an embodiment 14.

FIG. 27 is a system configuration diagram illustrating one example of a configuration of a MEMS mirror type projection system according to an embodiment 15.

### MODE FOR CARRYING OUT THE INVENTION

Hereinafter, modes for embodying a technology of the present disclosure (hereinafter, referred to as “embodiments”) will be described in detail with reference to the accompanying drawings. The technology of the present disclosure is not limited to the embodiments, and various numerical values and the like in the embodiments are merely illustrative. In the description given below, the same components or components having the same functions are denoted by the same reference signs, and overlapping description will be omitted. Note that the description will be given in the following order.

1. Overall description as to a display apparatus and a projection system of the present disclosure

2. As to an outline of a projection system
2-1. A basic system configuration example
2-2. A driving example according to the conventional technology

3. A display apparatus according to each embodiment
3-1. Embodiment 1 (an example in which as a solid-state light source, a semiconductor laser is used and as a light modulation device, MEMS mirrors are used)
3-2. Embodiment 2 (which is an implementation example 1 of a solid-state light source and an example in which a plurality of solid-state light sources whose light emitting luminances are different from one another is arranged)
3-3. Embodiment 3 (which is an implementation example 2 of a solid-state light source and an example in which solid-state light sources whose light emitting luminances are different from one another, each number of the solid-state light sources being in accordance with each required luminance ratio)
3-4. Embodiment 4 (an example in which solid-state light source fluorescent bodies are used and a light quantity is adjusted by a variable light quantity adjusting filter on a stage subsequent thereto)
3-5. Embodiment 5 (which is a modified example of an embodiment 4 and an example in which instead of a light control element, a rotary circular ND filter is used)
3-6. Embodiment 6 (which is a control example 1 of a display apparatus and an example in which light emitting time of bits of low gradations is shortened)
3-7. Embodiment 7 (which is a control example 2 of a display apparatus and an example in which a light source luminance for each gradation bit is controlled by pulse width modulation)
3-8. Embodiment 8 (which is a control example 3 of a display apparatus and an example in which a combination of a light emitting luminance and a stop is changed in accordance with a video source)
3-9. Embodiment 9 which is a control example 4 of a display apparatus and an example of order of bit sequences)

4. A projection system according to each embodiment
4-1. Embodiment 10 (which is an example of a three-plate type in which an application processor performs synchronization control)
4-2. Embodiment 11 (which is an example of a three-plate type in which a MEMS control unit performs synchronization control)
4-3. Embodiment 12 (which is an example of a single plate type in which an application processor performs synchronization control)
4-4. Embodiment 13(which is an example of single plate type in which a MEMS control unit performs synchronization control)
4-5. Embodiment 14 (which is an example of a light source time division type in which an application processor performs synchronization control)
4-6. Embodiment 15 (which is an example of a light source time division type in which a MEMS control unit performs synchronization control)

5. MODIFIED EXAMPLE

6. Configurations which the present disclosure can have

### <Overall Description as to a Display Apparatus and a Projection System of the Present Disclosure>

In a display apparatus and a projection system of the present disclosure, a light modulation device can be constituted of an on-state/off-state binary display device and preferably, can be constituted of MEMS mirrors.

In the display apparatus and the projection system of the present disclosure, which includes the above-mentioned preferred configuration, a light source of a first optical system can be constituted of a solid-state light source. The solid-state light source can be configured by using a semiconductor laser, light emitting diodes, or organic light emitting diodes.

In addition, in the display apparatus and the projection system of the present disclosure, which includes the above-mentioned preferred configuration, a light modulation unit can be constituted of a variable diaphragm part.

In addition, in the display apparatus and the projection system of the present disclosure, which includes the above-mentioned preferred configuration, the light source of the first optical system can be configured by arranging a plurality of solid-state light sources whose light emitting luminances are different from one another in an array state or by arranging solid-state light sources whose light emitting luminances are different from one another, each number of the solid-state light sources being in accordance with each required luminance ratio.

In addition, in the display apparatus and the projection system of the present disclosure, which includes the above-mentioned preferred configuration, the first optical system can be configured by a combination of fluorescent bodies and a variable light quantity adjusting filter. As the variable light quantity adjusting filter, an ND filter can be used.

In addition, in the display apparatus and the projection system of the present disclosure, which includes the above-mentioned preferred configuration, the light modulation unit can be configured by a rotary circular ND filter in which a plurality of ND filters whose transmissivities are different from one another is arranged in a circumferential direction and which can rotate.

In addition, in the display apparatus and the projection system of the present disclosure, which includes the above-mentioned preferred configuration, a control unit can be configured so as to make light emitting time of a least significant bit or light emitting time of bits of low gradations, which includes the least significant bit, shorter than light emitting time of the other bits. Alternatively, the control unit can be configured so as to control a light source luminance of each gradation bit by pulse width modulation.

In addition, in the display apparatus and the projection system of the present disclosure, which includes the above-mentioned preferred configuration, the control unit can be configured so as to change a combination of a light emitting luminance of the solid-state light source and a stop of the variable diaphragm part in accordance with a video source. As the video source, a sport, a variety show, an animation, or a movie can be cited as an example.

In addition, in the display apparatus and the projection system of the present disclosure, which includes the above-mentioned preferred configuration, the control unit can be configured so as to make bit arrangement of a first frame and bit arrangement of a second frame inverse to each other with respect to a boundary between the frames in a sequence with the first frame and the second frame as one set.

### <As to an Outline of a Projection System >

A display apparatus of the present disclosure can be used as a projection system (projector/projection type display apparatus). Herein, an outline of a MEMS mirror type projection system, as the projection system to which the display apparatus of the present disclosure is applied, in which electromagnetic drive type mirrors (the so-called MEMS mirrors) to which, for example, a micro electro mechanical systems (MEMS) technology is applied are used as a light modulation device, will be described. Each of the MEMS mirrors is an on/off binary display device (reflection type light modulation device/light modulator).

### [A Basic System Configuration Example]

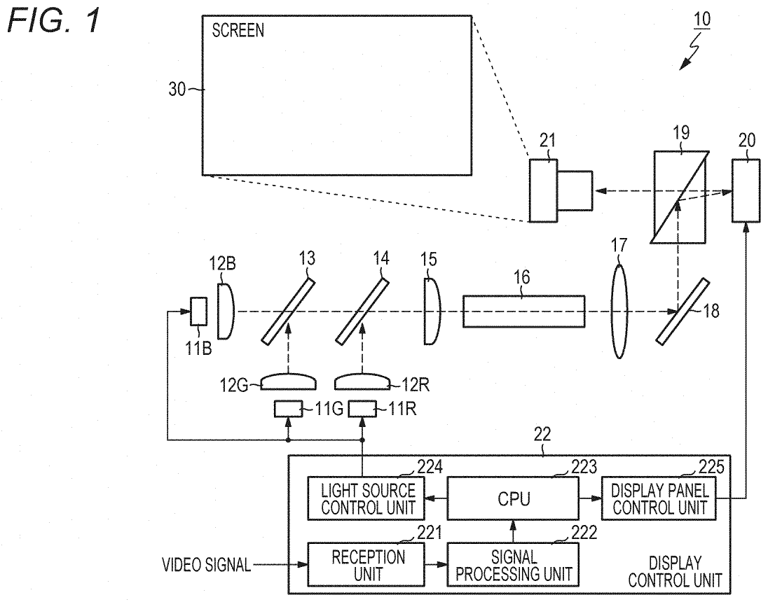

FIG. 1 is a system configuration diagram illustrating one example of a basic system configuration of a projection system. Herein, a system configuration in which a single display panel, that is, a single plate is used will be described.

As illustrated in FIG. 1, the projection system 10 according to the present embodiment includes solid-state light sources 11R, 11G, and 11B of R (a red color), G (a green color), and B (a blue color). Light radiated from the solid-state light sources 11R, 11G, and 11B of R, G, and B passes through lenses 12R, 12G, and 12B and thereafter, enters a rod integrator 16 via dichroic mirrors 13 and 14 and a lens 15.

The light uniformized by the rod integrator 16 passes through a lens 17, a mirror 18, and a total reflection prism 19 and is radiated to a display panel 20. The total reflection prism 19 is constituted of a combination of two triangular prisms. The display panel 20 is configured by arranging pixels in a two-dimensional matrix state (matrix form), and each of the MEMS mirrors, which is the on/off binary display device, is provided for each of the pixels.

Control of the solid-state light sources 11R, 11G, and 11B and the display panel 20 is performed by a display control unit 22. The display control unit 22 has a reception unit 221, a signal processing unit 222, a central processing unit (CPU) 223, a light source control unit 224, and a display panel control unit 225.

In the display control unit 22 having the above-mentioned configuration, when the display panel 20 constituted of the single plate is used, under control performed by the CPU 223, the light source control unit 224 temporally controls light emission of light sources of the respective colors, that is, the solid-state light sources 11R, 11G, and 11B of R, G, and B. Under control performed by the CPU 223, the signal processing unit 222 subjects a video signal externally inputted via the reception unit 221 to predetermined signal processing and supplies video data to the display panel control unit 225.

Under control performed by the display panel control unit 225, in synchronization with the solid-state light sources 11R, 11G, and 11B of R, G, and B, the respective pixels of the display panel 20 transit to predetermined states. Then, pixels of the display panel 20 in bright states (on-states) are projected to a screen 30 via the total reflection prism 19 and a projection lens 21.

### [A Driving Example According to the Conventional Technology]

In the MEMS mirror type projection system 10 having the above-described configuration, since each of the MEMS mirrors provided for each of the pixels is the on/off binary display device, brightness of colors in the projection system 10 is controlled basically by using a pulse width modulation (PWM) technology. In addition, by combining the PWM technology with the well-known light modulation technology, a dynamic range (range of brightness) can be controlled without changing linearity of the whole PWM.

Here, as one example, operation in a case where 16 gradations are expressed by using four-bit operation, that is, four lengths of time will be described. Light in light quantities of 16 kinds of bit sequences (≈16 values) in total is sequentially emitted in combinations of four-value time periods. This is the so-called PWM, and each of the light emitting quantities has linearity of 2⁴ stages. In the combination with this PWM technology, a light modulation unit referred to as an iris is used. The light modulation unit transmits illumination light from the light sources and can adjust transmissivities thereof according to a scene or a mode. By the combination of the PWM technology and the light modulation technology, with the linearity of the whole PWM maintained, the dynamic range (range of brightness) can be changed.

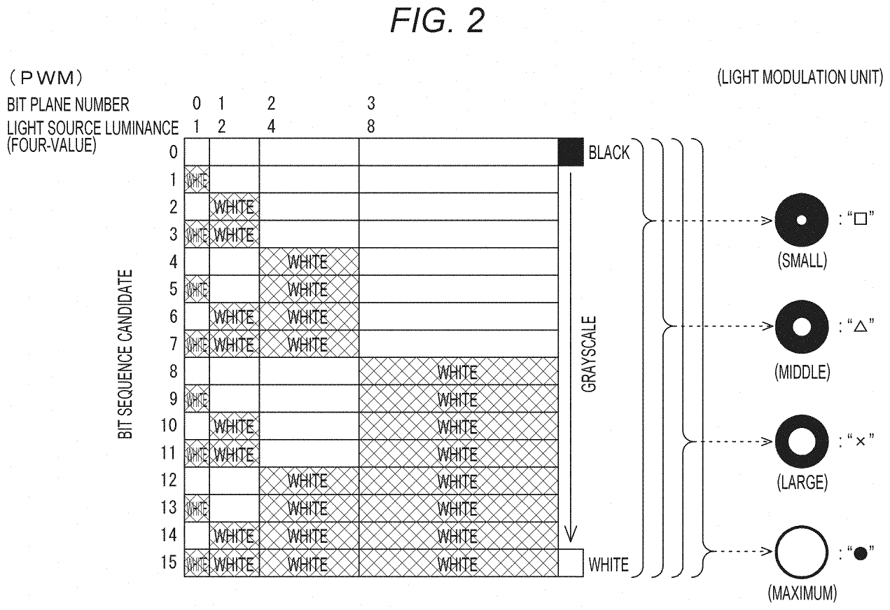

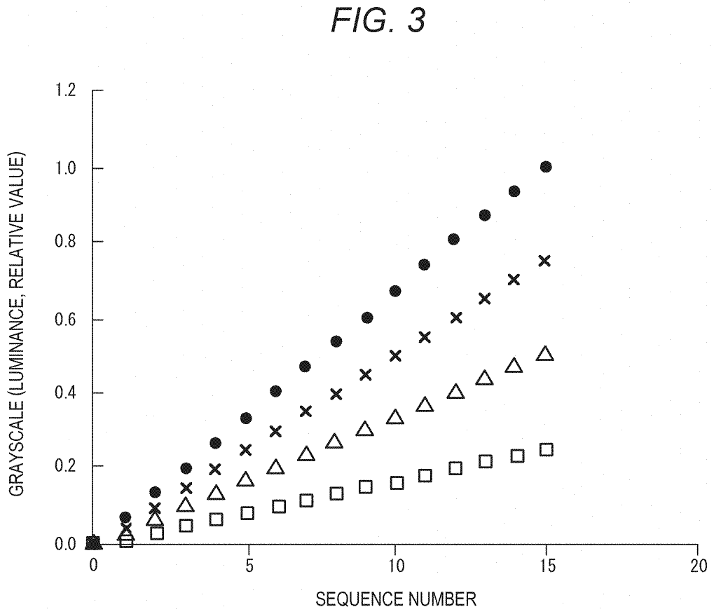

Relationship of combinations of illumination sequences and each opening of the diaphragm of the light modulation unit by the PWM technology of a driving example according to the conventional technology is shown in FIG. 2. In addition, a linear characteristic (relationship of a sequence number—a grayscale (a luminance, a relative value)) in a case where the binary light modulation device and the light modulation technology are simply linearly connected is shown in FIG. 3. In FIG. 3, marks “●” indicate results obtained when the opening of the diaphragm is maximum; marks “×” indicate results obtained when the opening of the diaphragm is relatively large; marks “Δ” indicate results obtained when the opening of the diaphragm is relatively middle; and marks “□” indicate results obtained when the opening of the diaphragm is relatively small, respectively.

As is clear from FIG. 3, although it can be said that in the driving example according to the conventional technology, which is constituted of the combination of the PWM technology and the light modulation technology, it is possible to optionally control the dynamic range of outputted light, each thereof is physically linear. In other words, in the MEMS mirror type projection system, due to a characteristic of the device (light modulation device), gradations which can be optically outputted are physically linear. However, since a person's luminosity factor is non-linear, the physically linear gradations which the above-mentioned video system outputs are perceived by a person's eyes as non-linear and unnatural gradations. Although in order for a person to perceive natural linear gradations, it is required to realize non-linear gradation expression (a gamma characteristic/a gamma curve) on an optical device side, as shown in FIG. 3, even by simply linearly connecting the binary light modulation device and the light modulation technology, the non-linear gradation expression cannot be realized.

### <Display Apparatuses According to Embodiments>

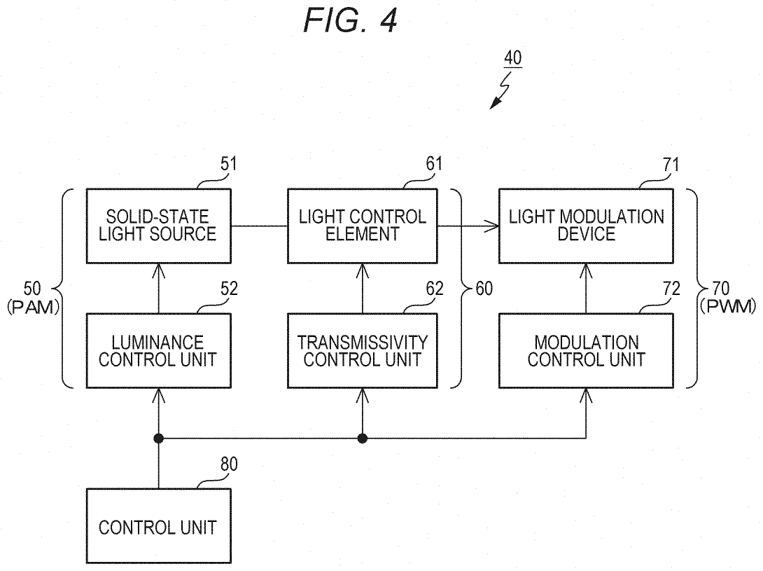

Therefore, in embodiments of the present disclosure, even in a case where the light modulation device is an on/off binary display device (for example, each of MEMS mirrors), it is made possible to realize non-linear gradation expression (a gamma characteristic/a gamma curve) required of a video system. A block diagram of a basic configuration of each of display apparatuses according to an embodiment of the present disclosure is illustrated in FIG. 4. A display apparatus 40 according to the present embodiment includes a first optical system 50 which generates illumination light whose light emitting luminance (light intensity) is variable; a light modulation unit 60 which has a variable transmissivity; a second optical system 70 which includes a light modulation device; and a control unit 80 which controls these.

The first optical system 50 has a solid-state light source 51 and a luminance control unit 52 which controls a light emitting luminance of the solid-state light source 51 and generates illumination light on n stages, whose light emitting luminances (light intensities) are different from one another, by using a pulse amplitude modulation (PAM) technology. The luminance control unit 52 controls the light emitting luminances of the illumination light generated by the first optical system 50 on the basis of an instruction value given from the control unit 80 (PAM technology).

The light modulation unit 60 has a light control element 61 which transmits the illumination light from the solid-state light source 51 and has a variable transmissivity and a transmissivity control unit 62 which controls the transmissivity of the light control element 61. The transmissivity control unit 62 controls the transmissivity of the light control element 61 on the basis of an instruction value given from the control unit 80, so that the transmissivity is adjusted to two or more stages.

The second optical system 70 has a light modulation device 71 such as MEMS mirrors and a modulation control unit 72 which controls the light modulation device 71 and optically modulates the illumination light from the first optical system 50, which has passed through the light modulation unit 60, by using the pulse width modulation (PWM) technology. As the light modulation device 71, an on/off binary display device (reflection type light modulation device), which is, for example, each of the MEMS mirrors, can be used. The modulation control unit 72 modulates the light on the basis of an instruction value given from the control unit 80, thereby controlling brightness of the colors (PWM technology).

In synchronization with a bit plane of n-bit PWM, the control unit 80 synchronously controls a light emitting luminance (light intensity) of the illumination light radiated from the solid-state light source 51 of the first optical system (PAM) 50 and the transmissivity of the light control element 61 of the light modulation unit 60 in any combination. Under control by this control unit 80, even in the case where the light modulation device is the on/off binary display device (for example, each of the MEMS mirrors), the non-linear gradation expression required of the video system can be realized.

Operation of the display apparatus 40 according to the present embodiment having the above-described configuration will be described. Herein, for the sake of simplification, operation in a case where 16 gradations are expressed by using 4-bit operation, that is, the four lengths of time will be described. In the present principle, expansion to n bits can be made.

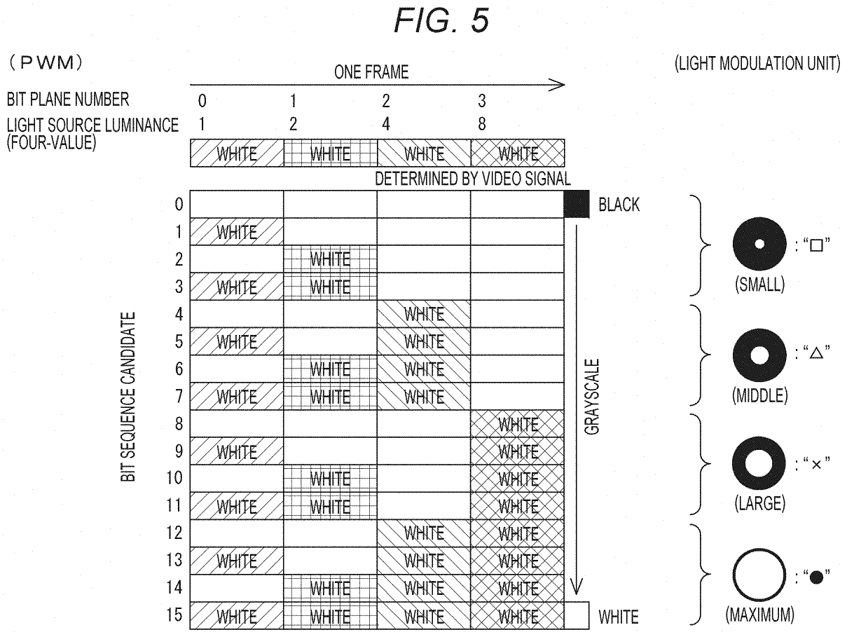

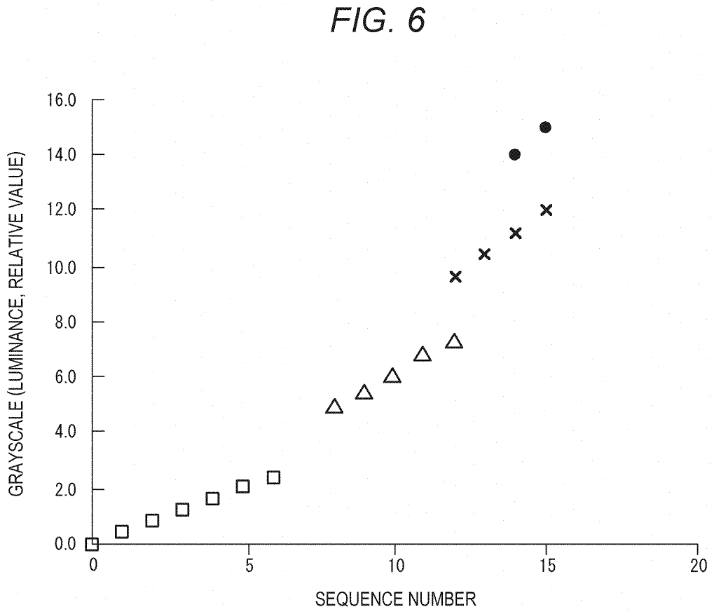

When under control by the luminance control unit 52, light of 4-value PAM (in which time is constant and there are four kinds of the light emitting luminances) emitted from the solid-state light source 51 is illuminated via the light control element 61 to the light modulation device 71 under PWM operation, as shown in FIG. 5, illumination sequences of 16 bit sequences (≈16 values) in total result. The light control element 61 provides transmissivities in synchronization with, for example, sequences 1 to 7, 8 to 12, 12 to 15, and 16. As a result, as shown in FIG. 6, non-linear sequences in gradations on 2⁴ stages can be realized.

As described above, the display apparatus 40 according to the present embodiment includes the first optical system 50 using the PAM technology and the second optical system 70 using the PWM technology and is configured to synchronously control the light emitting luminance of the illumination light from the first optical system 50 and the transmissivity of the light modulation unit 60 in any combination. Then, by employing the display apparatus 40 according to the present embodiment, the below-described working and effect can be obtained.
Even in a case where the light modulation device 71 is the on/off binary display device, non-linear gradation expression required of a video system can be realized.
Since assignment of luminance gradations in a black region can be increased, even in the case where the light modulation device 71 is the on/off binary display device, in accordance with a respect in that a resolution of a person's eyes is high in a dark portion, video display in which emphasis is placed on gradations in the dark portion can be realized.
As compared with time axis dispersion which is utilized to increase a number of gradations in the dark region in a pseudo manner in a binary device in general or region dispersion processing, middle gradation display having no rough noise can be realized.
Both of a dynamic range for which a digitally controlled light modulation device which is an on/off binary type, for example, a MEMS mirror device is superior and gradation expression for which an analog-controlled device, which uses liquid crystal such as liquid crystal on silicon (LCOS) and high temperature poly silicon (HIPS), is superior can be achieved.
Because of favorable compatibility with PWM sequences having equally long bits, time to control mechanical parts is alleviated and reduction in costs/downsizing can be realized.

Hereinafter, embodiments of display apparatuses according to the present embodiment for realizing the non-linear gradation expression will be described.

### Embodiment 1

An embodiment 1 is an example in which as a solid-state light source 51, for example, a semiconductor laser (LD) is used and as a light control element 61, for example, a variable diaphragm part (iris) is used. As the solid-state light source 51, besides the semiconductor laser (LD), other solid-state light source such as light emitting diodes (LEDs) and organic light emitting diodes (OLEDs) may be used.

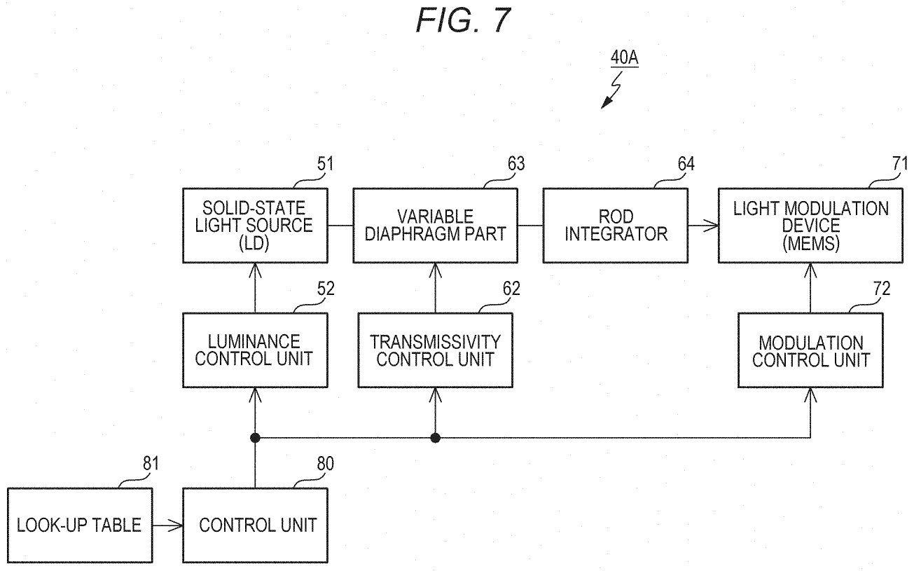

FIG. 7 is a block diagram illustrating a configuration of a display apparatus 40A according to the embodiment 1. The display apparatus 40A according to the embodiment 1 has a configuration in which as the solid-state light source 51, a semiconductor laser is used, as a light modulation device 71, MEMS mirrors are used, and a rod integrator 64 is included on a stage subsequent to the variable diaphragm part 63. Light emitted from the semiconductor laser as the solid-state light source 51 passes through the variable diaphragm part 63 and enters the rod integrator 64. The rod integrator 64 uniformizes the light from the solid-state light source 51 and irradiates the MEMS mirrors as the light modulation device 71 with the uniformized light.

On the basis of data previously stored in a look-up table 81, a control unit 80 provides an instruction value to determine a light emitting luminance of the solid-state light source 51 for a luminance control unit 52, an instruction value to determine a stop (transmissivity) of the variable diaphragm part 63 for a transmissivity control unit 62, and an instruction value to PWM-control the light modulation device 71 for a modulation control unit 72, respectively.

Also in the display apparatus 40A according to the embodiment 1 in which as the solid-state light source 51, the solid-state light source such as the semiconductor laser, the light emitting diodes, and the organic light emitting diodes is used and as the light control element 61, for example, the variable diaphragm part (iris) is used, working and effect similar to the working and effect obtained in the display apparatus 40 according to the embodiment of the present disclosure illustrated in FIG. 4 can be obtained.

### Embodiment 2

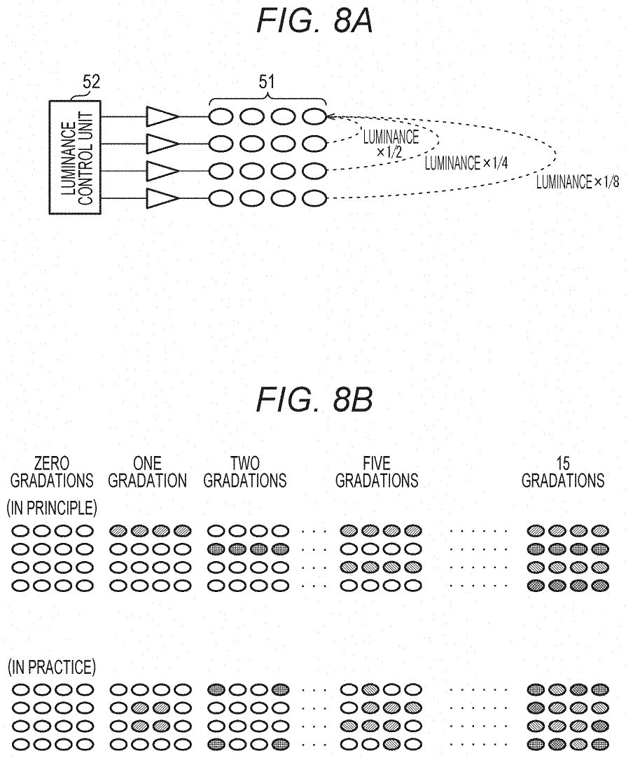

An embodiment 2 is an implementation example 1 of a solid-state light source (a light source of a first optical system 50) and is an example in which a plurality of solid-state light sources whose light emitting luminances are different from one another is arranged in an array state. A conceptual diagram of a configuration of a solid-state light source 51 according to the embodiment 2 is shown in FIG. 8A.

Here, an example in a case where one set of light sources is disposed by arranging four sets of four kinds of solid-state light sources whose light emitting luminances are different from one another in an array state with 16 solid-state light sources in total is illustrated. Note that although each of the exemplified numbers which is four is merely one example and the exemplified total number which is 16 is merely one example and the technology of the present disclosure is not limited thereto, from the point of view of ease of controlling an optical average value and of reduction in manufacturing costs as a result, designing a module even with each of the numbers being three or more has practical advantages. By combining the bit sequences and light emission of luminances, gradations can be produced. In principle, as shown on an upper stage of FIG. 8B, the 16 solid-state light sources in total which are arranged in the array state are caused to sequentially emit light in a unit of a row in each predetermined combination, thereby allowing 16 gradations to be produced.

In practice, as shown on a lower stage of FIG. 8B, in a manner in which four solid-state light sources in the middle are caused to emit the light, four solid-state light sources on outermost sides are next caused to emit the light, four on outer sides in positions of rotational displacement each by 45 degrees are caused to emit the light, . . . , each four solid-state light sources are caused to emit the light in a point-symmetrically arranged manner, thereby allowing the 16 gradations to be produced. In the latter case, by arranging the solid-state light sources, whose light emitting luminances are large, on the outer sides, advantages in that thermal resistance of an exhaust heat route can be reduced can be obtained. In addition, arranging the solid-state light source whose light emitting luminances are large in such a way as to be separated from one another has effect to prevent device characteristic deviation due to heat concentration and acceleration of deterioration. Also in either case, the above-described element is beneficial for cooling design of the solid-state light sources, and practical advantages of characteristic stabilization, downsizing of a cooling device, downsizing of the set in conjunction therewith, and reduction in costs of a cooling member can be obtained.

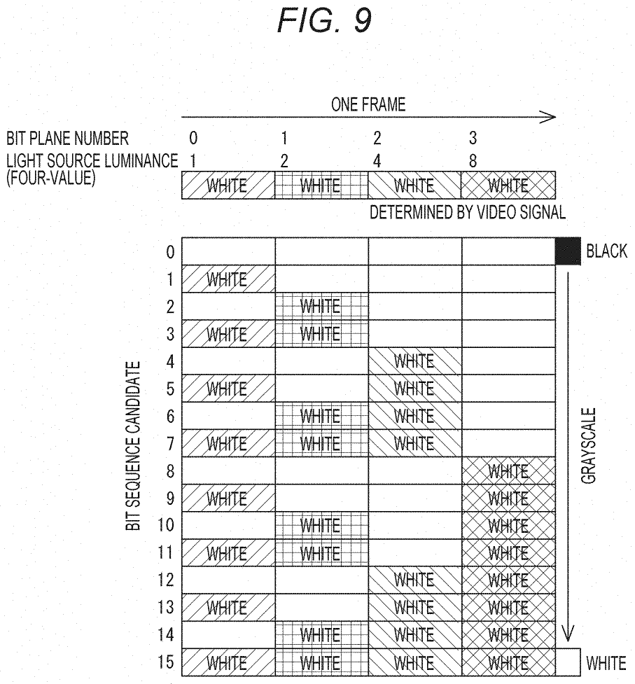

The individual solid-state light sources may be the semiconductor laser, the light emitting diodes, or the organic light emitting diodes or may be other solid-state light sources. In FIG. 9, a bit sequence diagram of a basic principle (simple color) of 4-bit grayscale according to the embodiment 2 is shown. Note that although here, a configuration for 4-bit PWM is exemplified, as to 8-bit PWM, 10-bit PWM, or the like, expansion can be made in the same principle.

As means for realizing the four kinds of solid-state light sources whose light emitting luminances are different from one another, the means may be realized by using four products, whose characteristics (light emitting luminances) are different from one another, which are mutually different products or the means may be realized by using one product and performing four kinds of current control. In a case of the former realization means, since it is only required to cause each of the four kinds of solid-state light sources whose light emitting luminances are different from one another to emit light with a constant current value, the luminance control unit 52 can be made inexpensive.

### Embodiment 3

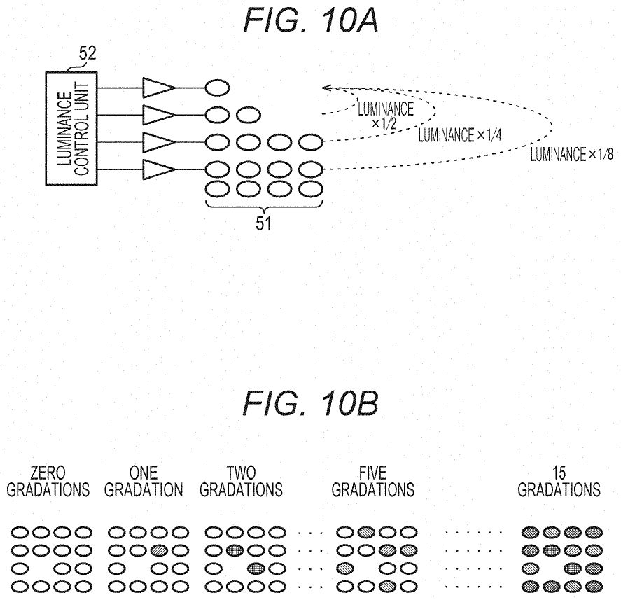

An embodiment 3 is an implementation example 2 of a solid-state light source (a light source of a first optical system 50) and is an example in which solid-state light sources whose light emitting luminances are equal to one another are arranged, each number of the arranged solid-state light sources being in accordance with each required luminance ratio. A conceptual diagram of a configuration of a solid-state light source 51 according to the embodiment 3 is shown in FIG. 10A, and combinations of light emission of the solid-state light sources according to the embodiment 3 is shown in FIG. 10B.

Herein, a case where one set of light sources in which the solid-state light sources whose light emitting luminances are equal to one another are arranged, each number of the arranged solid-state light sources being in accordance with each required luminance ratio is exemplified. Specifically, the solid-state light sources whose light emitting luminances are equal to each other or one another are arranged, and a total number of the arranged solid-state light sources is 15 with a number obtained by doubling one (two solid-state light sources), a number obtained by doubling the obtained doubled number (four solid-state light sources), and a number obtained by doubling the doubled obtained doubled number (eight solid-state light sources). By employing the light emission performed by these combinations of the solid-state light sources, the doubled light emitting luminances, the doubled light emitting luminances of the doubled light emitting luminances, and the doubled light emitting luminances of the doubled light emitting luminances of the doubled light emitting luminances can be provided. In this way, by combining the bit sequences and the light emission of the luminances, gradations can be produced.

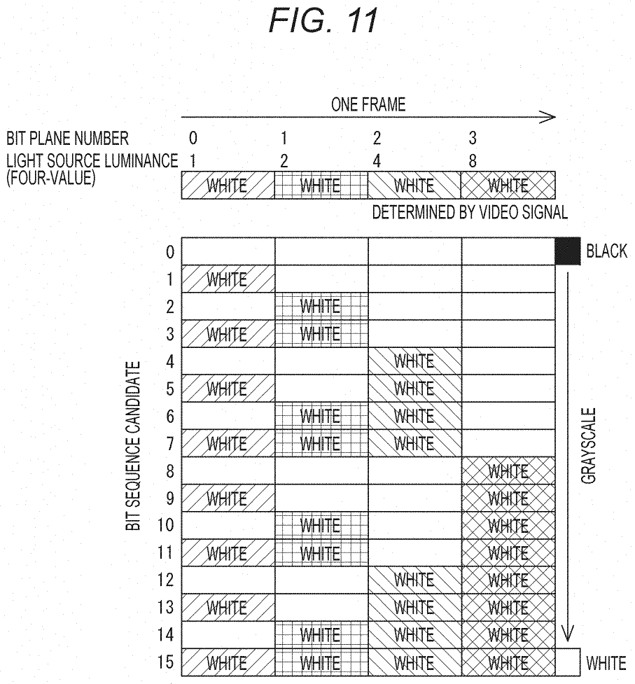

The individual solid-state light sources may be the semiconductor laser, the light emitting diodes, or the organic light emitting diodes or may be other solid-state light sources. In FIG. 11, a bit sequence diagram of a basic principle (simple color) of 4-bit grayscale according to the embodiment 3 is shown. Note that although here, a configuration for 4-bit PWM is exemplified, as to 8-bit PWM, 10-bit PWM, or the like, expansion can be made in the same principle.

According to the embodiment 3, the light sources of the first optical system 50 can be realized with an accumulation number of the solid-state light sources smaller than an accumulation number thereof in the embodiment 2 in which the solid-state light sources whose light emitting luminances are different from one another are arranged in the array state. In addition, since by making member specifications uniform, a cost price can be lowered, the light sources of the first optical system 50 can be manufactured more inexpensively than in a case of the embodiment 2. In addition, since the light emitting luminance of each of the solid-state light sources is one kind and the device can also be made to have the same specifications, it is easy to perform life design, and simplification of mounting processes/cost reduction in packaging processes can be devised. Further as shown in FIG. 10B, since the solid-state light sources which emit the light can be dispersively arranged, robustness in heat density design can be obtained.

### Embodiment 4

An embodiment 4 is an example in which as a solid-state light source 51, for example, fluorescent bodies are used and light quantity adjustment is performed by a variable light quantity adjusting filter which is located on a stage subsequent to the fluorescent bodies. As the solid-state light source 51, besides the fluorescent bodies, other solid-state light source such as quantum dots (QDs) may be used.

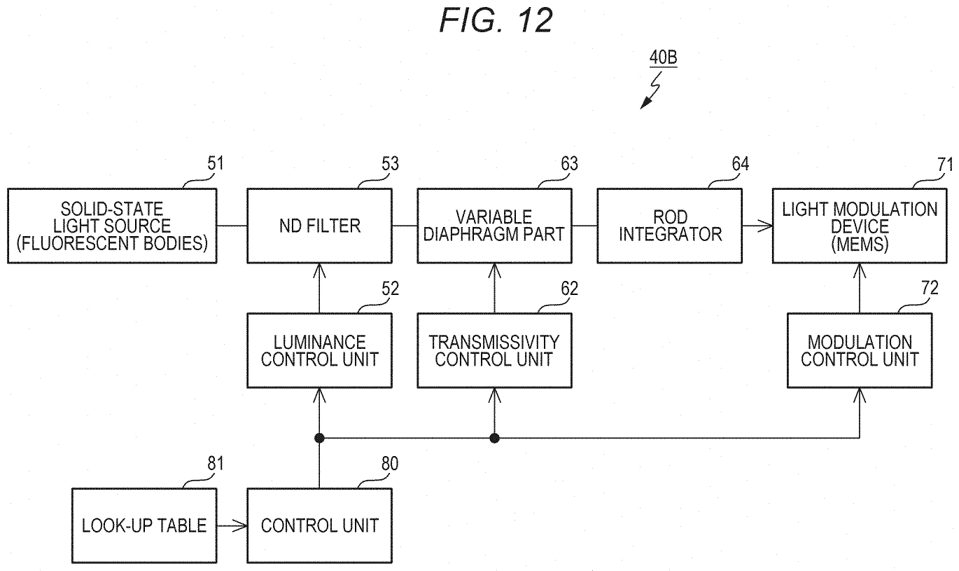

FIG. 12 is a block diagram illustrating a configuration of a display apparatus 40B according to the embodiment 4. In the configuration of the display apparatus 40B according to the embodiment 4, as the solid-state light source 51, the fluorescent bodies are used, and on the stage subsequent to the solid-state light source 51, as the variable light quantity adjusting filter, a neutral density (ND) filter 53 which can adjust only a light quantity without exerting any influence on color development is located.

In the display apparatus 40B according to the embodiment 4, on the basis of an instruction value given from a control unit 80, a luminance control unit 52 controls a transmissivity of the ND filter 53, thereby controlling a light emitting luminance of illumination light radiated from a first optical system 50.

Also by employing the display apparatus 40B according to the embodiment 4 in which as the solid-state light source 51, the fluorescent bodies or the QDs are used, working and effect similar to the working and effect obtained in the case of the display apparatus 40 according to the embodiment of the present disclosure illustrated in FIG. 4 can be obtained. In addition, using the fluorescent bodies or the QDs as the solid-state light source 51 has an advantage in that costs of the light source of the first optical system 50 is inexpensive, as compared with the case of the embodiment 1 in which the semiconductor laser, the light emitting diodes, or the organic light emitting diodes are used.

### Embodiment 5

An embodiment 5 is a modified example of the embodiment 4 and is an example in which instead of the variable diaphragm part 63, a rotary circular ND filter 65 is used.

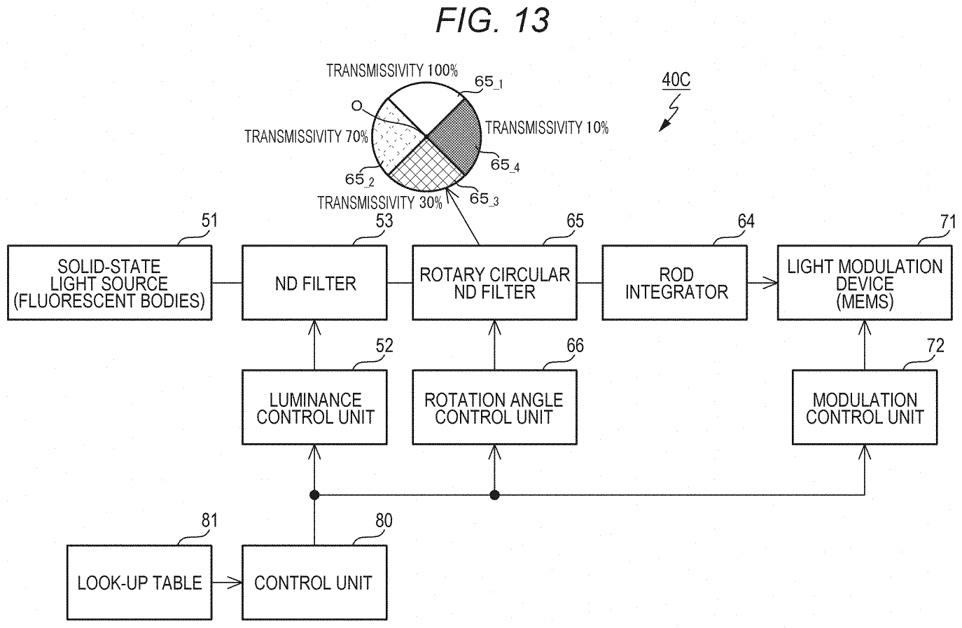

FIG. 13 is a block diagram illustrating a configuration of a display apparatus 40C according to the embodiment 5. In the configuration of the display apparatus 40C according to the embodiment 5, instead of the variable diaphragm part 63, the rotary circular ND filter 65 is used. The rotary circular ND filter 65 includes a plurality of ND filters whose transmissivities are different from one another, and in the present embodiment, film formation of ND filters 65_{_1}, 65_{_2}, 65_{_3}, and 65_{_4} whose transmissivities are, for example, 100%, 70%, 30%, and 10% is performed in arrangement relationship in which the ND filters 65_{_1}, 65_{_2}, 65_{_3}, and 65_{_4} are displaced by each 90 degrees in a circumferential direction, and the rotary circular ND filter 65 is configured to be rotatable with a rotational axis as a center.

The rotary circular ND filter 65 is rotationally driven by a rotation angle control unit 66. As the rotation angle control unit 66, for example, a stepping motor can be used. Under driving by the stepping motor, the rotary circular ND filter 65 rotates once in one frame and can thereby provide four kinds of transmissivities (100%, 70%, 30%, and 10%) in a bit sequence of one period. The control by the stepping motor may be constant-velocity control or may be control based on a controlled discrete velocity value.

By employing the display apparatus 40C according to the embodiment 5, since a mechanism of the rotary circular ND filter 65 is simpler than a mechanism of the variable diaphragm part (iris) 63, prolonging of a life/cost reduction of the display apparatus 40C can be devised. Since as to the rotation angle control unit 66, only PWM control of the stepping motor is performed, the rotation angle control unit 66 can be made extremely inexpensive, and moreover, control of the transmissivity at high accuracy can be provided. Furthermore, a light modulation unit which has a small number of driving parts and whose quietness is high can be provided.

### Embodiment 6

An embodiment 6 is a control example 1 of a display apparatus and a bit sequence example in which light emitting time as to a least significant bit (LSB) or bits of low gradations, which include the LSB, is made shorter than light emitting time as to the other bits.

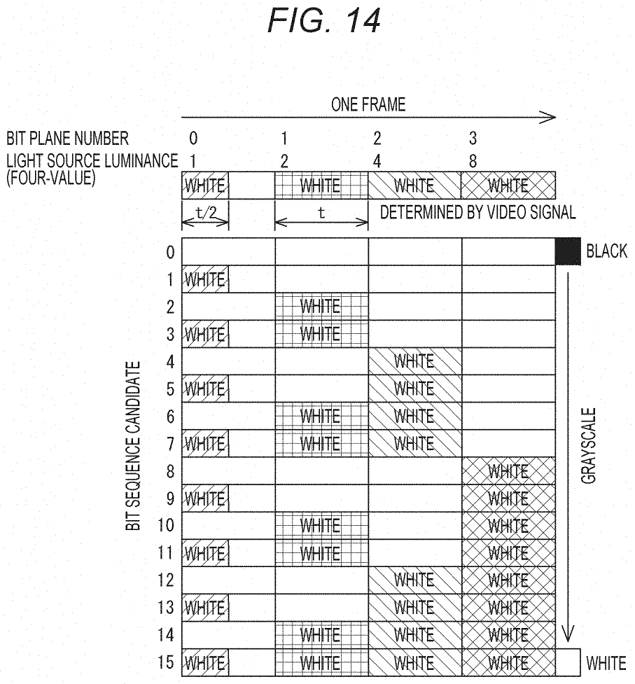

FIG. 14 is a bit sequence diagram of a basic principle (simple color) of 4-bit grayscale according to an embodiment 6. In the embodiment 2, as shown in FIG. 9, as to all of the bits, lengths of light emitting time are set to be the same as one another. In contrast to this, in the embodiment 6, under control by a control unit 80, light emitting time as to the LSB (or several bits for low gradations, which include the LSB) is made shorter than light emitting time as to the other bits, and specifically, the light emitting time as to the LSB (or the several bits for the low gradations, which include the LSB) is set to be, for example, t/2 which is a half of light emitting time t as to the other bits.

In the display apparatus 40A according to the embodiment 1, as to current control of the semiconductor laser (LD) as the solid-state light source 51, in consideration of ensuring a dynamic of light quantities, it is preferable that currents fully up to a threshold value are utilized. However, in a low current region, that is, in the vicinity of a lower threshold value, due to product variation of the solid-state light source 51, aging change of the product thereof, and the like, it is difficult to ensure stability of light emitting luminances.

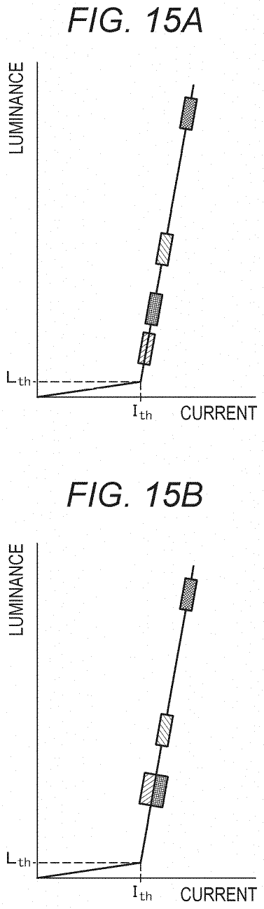

Therefore, in the embodiment 6, under the control by the control unit 80, as shown in FIG. 14, the length (t/2) of the light emitting time as to the LSB (zero bits) is made shorter than the length (t) of the light emitting time as to the other bits. A characteristic diagram of current-light emitting luminance in a case where the lengths of the light emitting time as to the bits are the same as one another is shown in FIG. 15A, and a characteristic diagram of current-light emitting luminance in a case where the length of the light emitting time as to the LSB is made shorter than the lengths of the light emitting time as to the other bits is shown in FIG. 15B. Although as to zero bit and one bit, light emission is controlled by the same current value, since the length of the light emitting time as to the zero bit is the half of the length of the light emitting time as to the other bits, a doubled luminance can be obtained.

As described above, employed in the embodiment 6 is the control method in which in the display apparatus 40A according to the embodiment 1, the length of the light emitting time as to the LSB (or the several bits for the low gradations, which include the LSB) is made shorter than the length of the light emitting time as to the other bits. By employing this control method according to the embodiment 6, robustness of the solid-state light source 51 with respect to the threshold value can be boosted, enhancement in light emission accuracy thereof and prolonging of a life thereof can be devised.

### Embodiment 7

An embodiment 7 is a control example 2 of a display apparatus and is an example in which a light source luminance of each gradation bit is controlled by pulse width modulation (PWM).

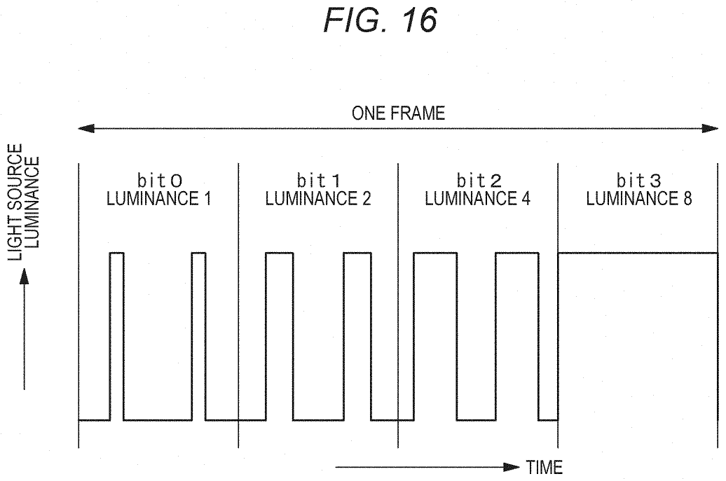

FIG. 16 is a timing waveform diagram in a case of control according to the embodiment 7. In a case of current control, since a current and a luminance are not proportional to each other, it is difficult to adjust the luminance by an absolute value. In contrast to this, in the embodiment 7, under control by a control unit 80, a light source luminance of each gradation bit is controlled by the PWM. By this control, the luminance of the solid-state light source 51 can be linearly controlled from 0% to 100%, and even when aging deterioration of the solid-state light source 51 is caused, a gradation characteristic can be maintained. In addition, although in the case of the current control, a wavelength is changed by a current value, in the case of the PWM control, color shade is not changed by the luminance.

### Embodiment 8

An embodiment 8 is a control example 3 of a display apparatus and is an example in which in accordance with a video source, a combination of light emitting luminance and a stop is changed.

Among video sources of, for example, a sport, a variety show, an animation, and a movie, there are differences in luminance distribution. For example, in the movie, there are many dark scenes, as compared with the sport. Since a MEMS mirror type projection system is a digital and discrete video system, all of the luminance distribution cannot be displayed at 1:1 in principle.

Therefore, in the embodiment 8, for example, in the display apparatus 40A according to the embodiment 1, in order to change a combination of a light emitting luminance of a solid-state light source 51 and a stop of a variable diaphragm part (iris) 63 in accordance with a video source under control by a control unit 80, control sequences corresponding to a plurality of gamma characteristics (gamma curves) are provided from a look-up table 81.

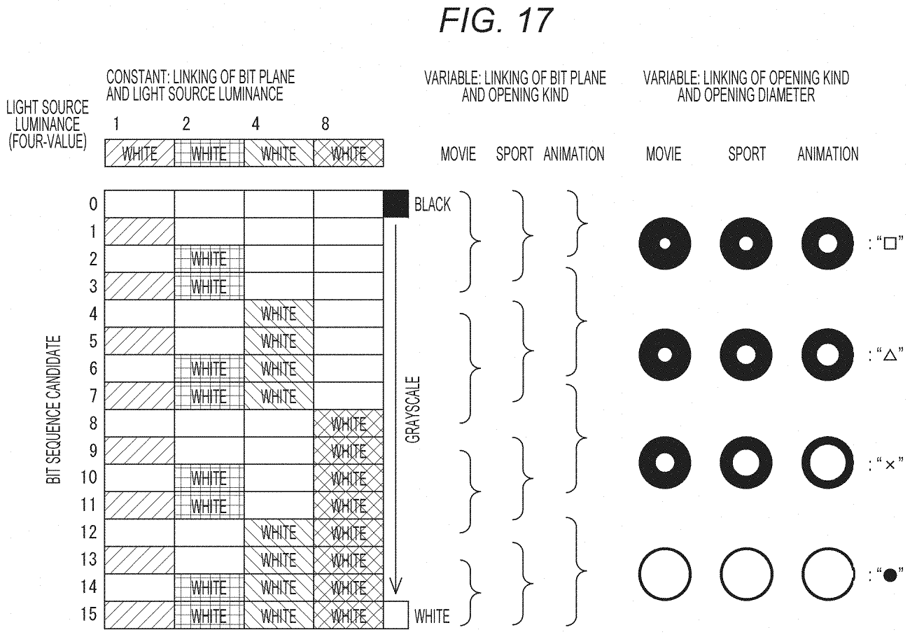

An example of a design method of the look-up table according to the embodiment 8 is shown in FIG. 17. In FIG. 17, linking of a bit plane and a light source luminance, linking of the bit plane and an opening kind of the variable diaphragm part 63, and linking of the opening kind and an opening diameter of the variable diaphragm part 63 are illustrated.

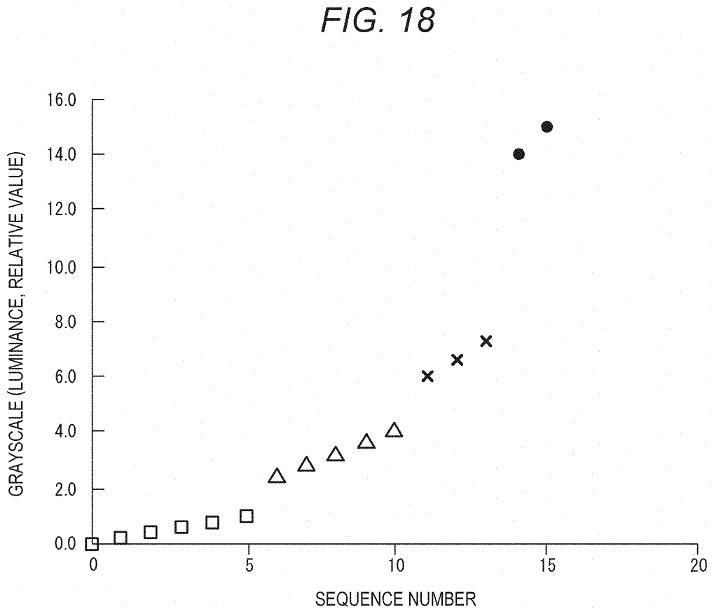

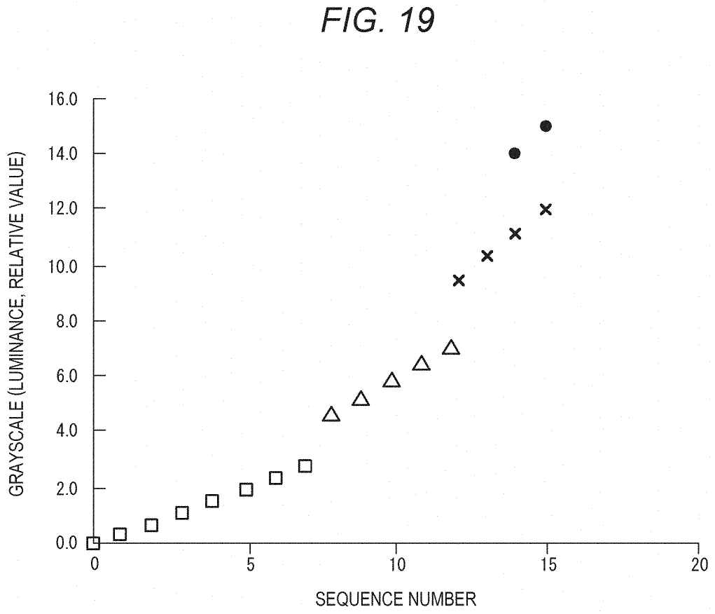

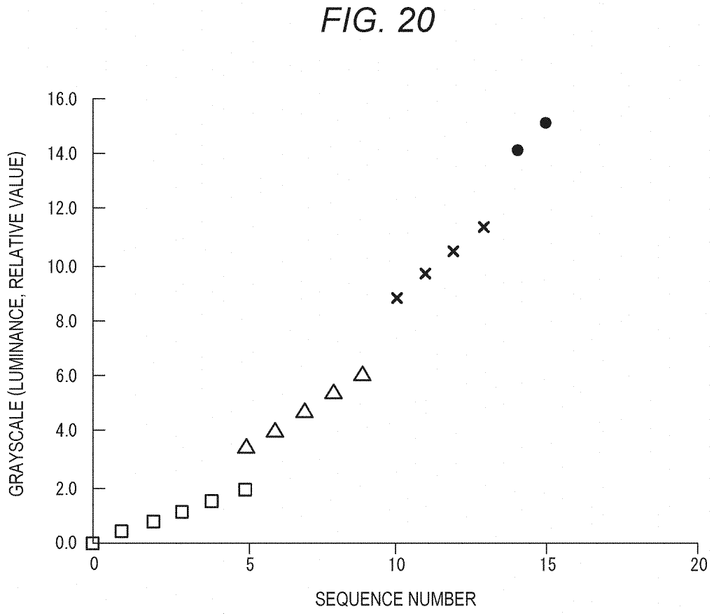

As described above, in a technology according to the embodiment 8, under the control by the control unit 80, in accordance with the video source, the combination of the light emitting luminance and the stop is changed. Driving results for respective video sources in the technology according to the embodiment 8 are shown in FIG. 18, FIG. 19, and FIG. 20. FIG. 18 shows the driving result in the technology according to the embodiment 8 in a case where the video source is the movie, FIG. 19 shows the driving result in the technology according to the embodiment 8 in a case where the video source is the sport, and FIG. 20 shows the driving result in the technology according to the embodiment 8 in a case where the video source is the animation.

Specifically, by employing the technology according to the embodiment 8, the below-described working and effect can be obtained.
For example, since in the movie, gradations closer to black are required in general, a resolution of the gradations of black portions can be weighted by the present technology.
For example, since in the sport, gradations in an intermediate region are required in general, a resolution of middle gradations can be weighted by the present technology.
For example, since in the animation or the variety show, a gradation in a white region is required in general, a resolution of a white gradation can be weighted by the present technology.
In any of the video sources, it is made possible to optionally select gradation expression with a luminance dynamic range within a screen maintained.
In any of the video sources, it is made possible to correct the luminance dynamic range within the screen and to optionally select the gradation expression. For example, in a dynamic range in which the white region in the movie or an indoor video or a black region in an outdoor sport is omitted, the gradation or the gradations are weighted, thereby allowing image quality to be improved.

### Embodiment 9

An embodiment 9 is a control example 4 of a display apparatus and is an example of order of bit sequences. Although display order of a bit plane in a basic principle ranges from the darkest portion (LSB) toward the brightest potion (MSB), in this case, a large luminance difference is caused in a boundary (joint) between frames. There may be a case where this luminance difference in the boundary between the frames is visually recognized as a flicker by a person's eyes.

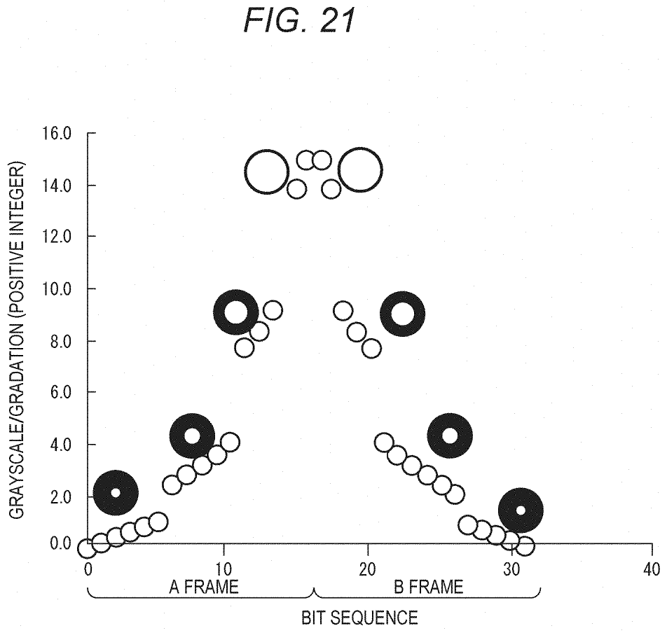

One example of the order of the bit sequences according to the embodiment 9 is shown in FIG. 21. The bit sequences according to the embodiment 9 are sequences constituted of a first frame (A frame) and a second frame (B frame) as one set, and under control by a control unit 80, bit arrangement of the A frame and bit arrangement of the B frame are made inverse to each other with respect to the boundary between the frames. More specifically, as to the display order of the bit plane, the order in the A frame is LSB=>MSB and the order in the B frame is MSB=>LSB.

In the above-described order of the bit sequences according to the embodiment 9, since a maximum value of a change amount of a light quantity of a light source can be alleviated, that is, the luminance difference in the boundary (joint) between the frames can be suppressed to be small, a flicker stemming from the above-mentioned luminance difference can be prevented. In addition, since in opening control of a variable diaphragm part 63, a maximum value of a movement amount of an actuator can be alleviated, accuracy of the opening control can be enhanced, and power saving and downsizing of the variable diaphragm part 63 can be devised.

### <Projection System According to Each Embodiment>

A display apparatus to which the technology according to each of an embodiment 1 to an embodiment 9 is applied (that is, a display apparatus according to each of the embodiments of the present disclosure) can be employed for a MEMS mirror type projection system. Hereinafter, specific embodiments of the MEMS mirror type projection system according to the embodiments of the present disclosure will be described as an embodiment 10 to an embodiment 15.

Also in the MEMS mirror type projection system according to any of the embodiment 10 to the embodiment 15 described hereinafter, by using the display apparatus to which the technology according to each of the embodiment 1 to the embodiment 9 is applied, the below-described working and effect can be obtained. In other words, even when a light modulation device is an on/off binary display device, non-linear gradation expression can be realized and a video display with emphasis placed on gradations of a dark portion in accordance with the respect that a resolution of a person's eyes is high in the dark portion can be realized. Furthermore, as compared with time axis dispersion which is utilized to increase a number of gradations in a dark region in a pseudo manner in a binary device in general or region dispersion processing, middle gradation display having no rough noise can be realized. In addition, both of a dynamic range for which a digitally controlled light modulation device which is an on/off binary type, for example, a MEMS mirror device is superior and gradation expression for which an analog-controlled device, which uses liquid crystal such as liquid crystal on silicon (LCoS) and high temperature poly silicon (HIPS), is superior can be achieved. Furthermore, because of favorable compatibility with PWM sequences having equally long bits, time to control mechanical parts is alleviated and reduction in costs/downsizing can be realized.

### Embodiment 10

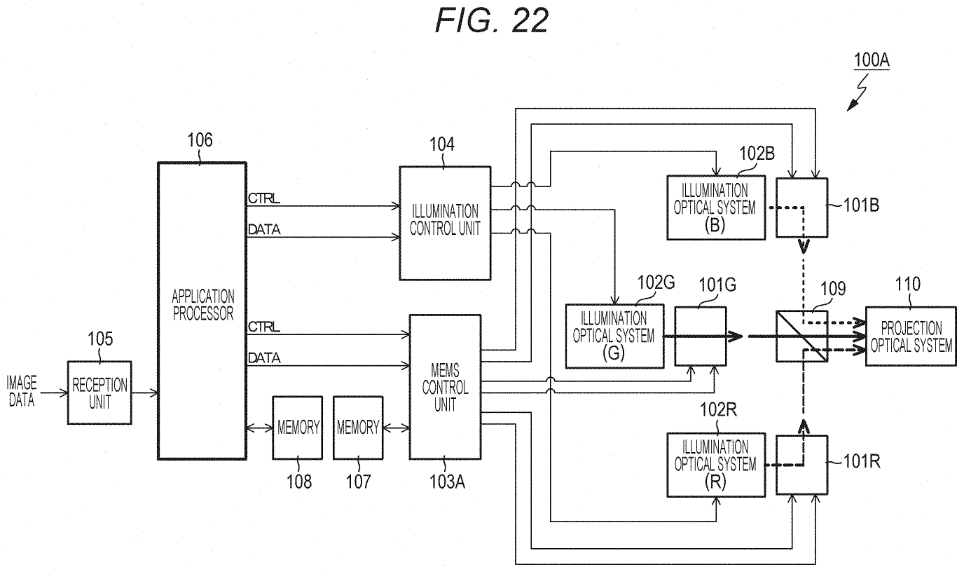

An embodiment 10 is an example of a three-plate type MEMS mirror type projection system and is an example in which an application processor performs synchronization control. One example of a configuration of the MEMS mirror type projection system according to the embodiment 10 is illustrated in FIG. 22.

As illustrated in FIG. 22, the MEMS mirror type projection system 100A according to the embodiment 10 is the three-plate type projection system (projection type display apparatus) which includes light modulation panels 101R, 101G, and 101B of R (red color), G (green color), and B (blue color). On each of the light modulation panels 101R, 101G, and 101B, MEMS mirrors, each of which is an on/off binary display device, are two-dimensionally arranged in a matrix state.

The MEMS mirror type projection system 100A according to the embodiment 10 further includes illumination optical systems 102R, 102G, and 102B of R, G, and B, which correspond to the light modulation panels 101R, 101G, and 101B. For each of the light modulation panels 101R, 101G, and 101B, on/off control of each of MEMS mirrors is performed by a MEMS control unit 103A. For each of the illumination optical systems 102R, 102G, and 102B, control of light emitting luminance of a solid-state light source is performed by an illumination control unit 104.

Externally inputted image data is supplied via a reception unit 105, which corresponds to an interface, to an application processor 106. The application processor 106 performs various kinds of image processing such as gamma correction.

The image data which has passed through the application processor 106 is converted into a bit plane format in the MEMS control unit 103A. A memory 107 and a memory 108 are attendantly provided for the MEMS control unit 103A and the application processor 106, respectively.

Transmission of bit plane data from the MEMS control unit 103A to the light modulation panels 101R, 101G, and 101B is scheduled by the application processor 106, and the bit plane data is transmitted in accordance with a predetermined PWM sequence. At this time, the application processor 106 transmits control data, which corresponds to a luminance level of a bit plane, to the illumination control unit 104.

In synchronization with a PWM sequence in which a bit plane image is displayed on the light modulation panels 101R, 101G, and 101B of R, G, and B, the illumination control unit 104 controls the illumination optical systems 102R, 102G, and 102B of R, G, and B. MEMS mirrors of the light modulation panels 101R, 101G, and 101B of R, G, and B, which are illuminated by the illumination optical systems 102R, 102G, and 102B of R, G, and B, perform on/off operation in accordance with the bit plane. Then, RGB light of pixels in a state in which the MEMS mirrors are turned on is projected (incident on) through a combiner 109 and a projection optical system 110 to a screen (not illustrated) or the like.

In the three-plate type MEMS mirror type projection system 100A having the above-described configuration according to the embodiment 10, as to correspondence relationship with the display apparatus 40 according to the embodiment of the present disclosure illustrated in FIG. 4, the illumination optical systems 102R, 102G, and 102B of R, G, and B and the illumination control unit 104 correspond to the first optical system 50 which generates illumination light, whose light emitting luminance (light intensity) is variable, by using the PAM technology. Note that in an output stage portion of each of the illumination optical systems 102R, 102G, and 102B, a light modulation unit 60 in which transmissivity is variable is included. In addition, the light modulation panels 101R, 101G, and 101B of R, G, and B and the MEMS control unit 103A correspond to the second optical system 70 which modulates illumination light from the illumination optical systems 102R, 102G, and 102B by using the PWM technology.

Then, in the three-plate type MEMS mirror type projection system 100A according to the embodiment 10, the application processor 106 corresponds to the control unit 80 in FIG. 4, and synchronization control of the first optical system 50 and the second optical system 70 is performed by the application processor 106.

### Embodiment 11

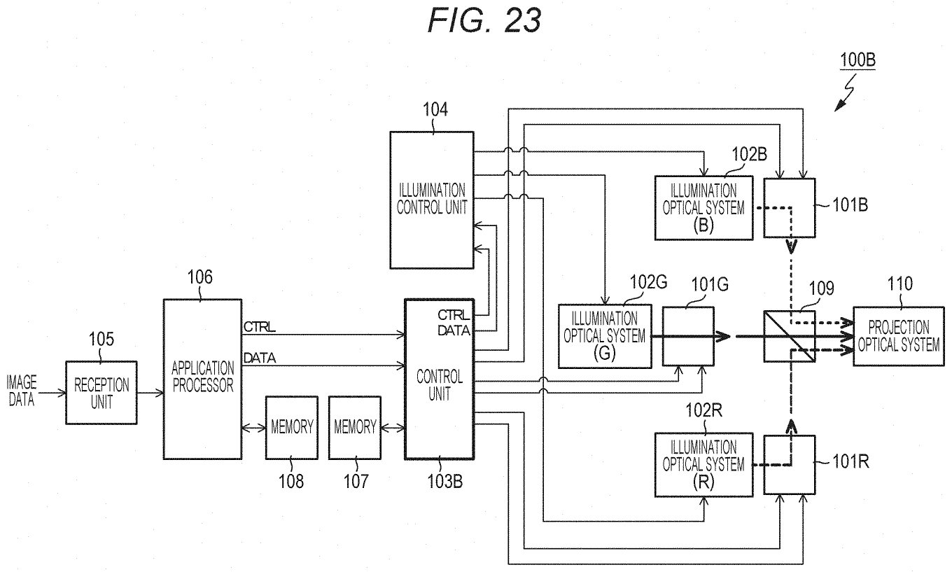

An embodiment 11 is an example of a three-plate type MEMS mirror type projection system and is an example in which a MEMS control unit performs synchronization control. One example of a configuration of the MEMS mirror type projection system according to the embodiment 11 is illustrated in FIG. 23.

A basic system configuration of the three-plate type MEMS mirror type projection system 100B according to the embodiment 11 is the same as that of the three-plate type MEMS mirror type projection system 100A according to the embodiment 10. However, the three-plate type MEMS mirror type projection system 100B according to the embodiment 11 is different from the three-plate type MEMS mirror type projection system 100A according to the embodiment 10 in that whereas in the three-plate type MEMS mirror type projection system 100A according to the embodiment 10, the application processor 106 performs the synchronization control for the first optical system 50 and the second optical system 70, in the three-plate type MEMS mirror type projection system 100B according to the embodiment 11, a control unit 103B performs the synchronization control therefor.

In the three-plate type MEMS mirror type projection system 100B according to the embodiment 11, externally inputted image data is supplied via a reception unit 105 to an application processor 106 and is subjected to various kinds of image processing such as gamma correction. The image data which has passed through the application processor 106 is converted into to a bit plane format (or PWM) in the control unit 103B.

Transmission of bit plane data from the control unit 103B to the light modulation panels 101R, 101G, and 101B is scheduled inside the control unit 103B, and the bit plane data is transmitted in accordance with a predetermined sequence. At this time, the control unit 103B transmits control data, which corresponds to a luminance level of a bit plane, to an illumination control unit 104.

In synchronization with a PWM sequence in which a bit plane image is displayed on the light modulation panels 101R, 101G, and 101B of R, G, and B, the illumination control unit 104 controls the illumination optical systems 102R, 102G, and 102B of R, G, and B. MEMS mirrors of the light modulation panels 101R, 101G, and 101B of R, G, and B, which are illuminated by the illumination optical systems 102R, 102G, and 102B of R, G, and B, perform on/off operation in accordance with the bit plane. Then, RGB light of pixels in a state in which the MEMS mirrors are turned on is projected (incident on) through a combiner 109 and a projection optical system 110 to a screen (not illustrated) or the like.

As described above, in the three-plate type MEMS mirror type projection system 100B according to the embodiment 11, the control unit 103B corresponds to the control unit 80 in FIG. 4, and synchronization control of the first optical system 50 and the second optical system 70 is performed by the control unit 103B.

### Embodiment 12

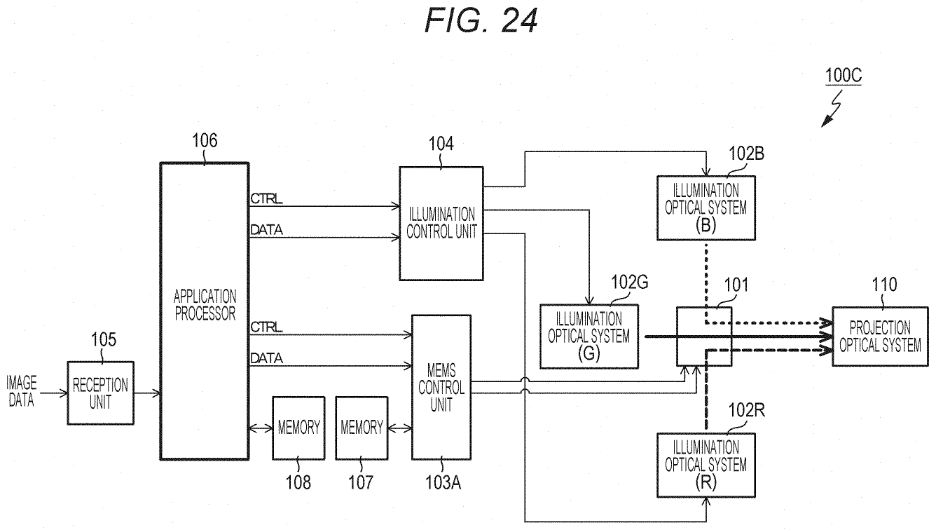

An embodiment 12 is an example of a single plate type MEMS mirror type projection system and is an example in which an application processor performs synchronization control. One example of a configuration of the MEMS mirror type projection system according to the embodiment 12 is illustrated in FIG. 24.

As illustrated in FIG. 24, the MEMS mirror type projection system 100C according to the embodiment 12 is a single plate type projection system (projection type display apparatus) in which a light modulation panel 101 is provided in common as a second optical system 70 for illumination optical systems 102R, 102G, and 102B of R, G, and B. In the light modulation panel 101, MEMS mirrors, each of which is an on/off binary display device, are two-dimensionally arranged in a matrix state.

In the three-plate type MEMS mirror type projection system 100C according to the embodiment 12, externally inputted image data is supplied via a reception unit 105 to an application processor 106 and is subjected to various kinds of image processing such as gamma correction. The image data which has passed through the application processor 106 is converted into a bit plane format (or PWM) in a MEMS control unit 103A.

Transmission of bit plane data from the MEMS control unit 103A to the light modulation panel 101 is scheduled by the application processor 106 and the bit plane data is transmitted in accordance with a predetermined PWM sequence. At this time, the application processor 106 transmits control data, which corresponds to a luminance level of a bit plane, to the illumination control unit 104.

In synchronization with a PWM sequence in which a bit plane image is displayed on the light modulation panel 101, the illumination control unit 104 controls illumination optical systems 102R, 102G, and 102B of R, G, and B. MEMS mirrors of the light modulation panel 101, which are illuminated by the illumination optical systems 102R, 102G, and 102B of R, G, and B, perform on/off operation in accordance with a bit plane. Then, RGB light of pixels in a state in which the MEMS mirrors are turned on is projected (incident on) through a combiner 109 and a projection optical system 110 to a screen (not illustrated) or the like.

As described above, in the single plate type MEMS mirror type projection system 100C according to the embodiment 12, the application processor 106 corresponds to the control unit 80 in FIG. 4, and synchronization control of a first optical system 50 and a second optical system 70 is performed by the application processor 106.

### Embodiment 13

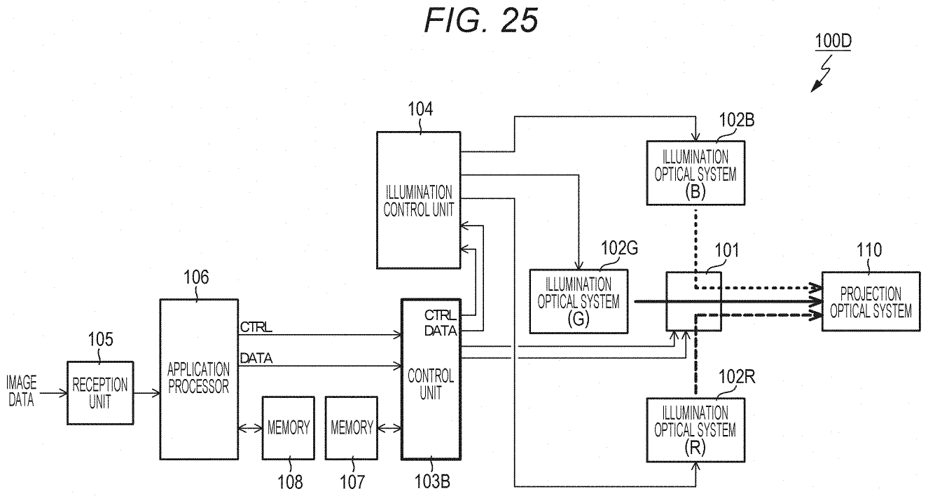

An embodiment 13 is an example of a single plate type MEMS mirror type projection system, and one example of a configuration of the MEMS mirror type projection system according to the embodiment 13 which is an example in which a MEMS control unit performs synchronization control is illustrated in FIG. 25.

A basic system configuration of the single plate type MEMS mirror type projection system 100D according to the embodiment 13 is the same as that of the single plate type MEMS mirror type projection system 100C according to the embodiment 12. However, the single plate type MEMS mirror type projection system 100D is different from the single plate type MEMS mirror type projection system 100C in that whereas in the single plate type MEMS mirror type projection system 100C according to the embodiment 12, synchronization control of a first optical system 50 and a second optical system 70 is performed by the application processor 106, in the single plate type MEMS mirror type projection system 100D according to the embodiment 13, synchronization control thereof is performed by a control unit 103B.

In the single plate type MEMS mirror type projection system 100D according to the embodiment 13, externally inputted image data is supplied via a reception unit 105 to an application processor 106 and is subjected to various kinds of image processing such as gamma correction. The image data which has passed through the application processor 106 is converted into to a bit plane format (or PWM) in the control unit 103B.

Transmission of bit plane data from the control unit 103B to a light modulation panel 101 is scheduled inside the control unit 103B, and the bit plane data is transmitted in accordance with a predetermined sequence. At this time, the control unit 103B transmits control data, which corresponds to a luminance level of a bit plane, to an illumination control unit 104.

In synchronization with a PWM sequence in which a bit plane image is displayed on the light modulation panel 101, the illumination control unit 104 controls illumination optical systems 102R, 102G, and 102B of R, G, and B. MEMS mirrors of the light modulation panel 101, which are illuminated by the illumination optical systems 102R, 102G, and 102B of R, G, and B, perform on/off operation in accordance with a bit plane. Then, RGB light of pixels in a state in which the MEMS mirrors are turned on is projected (incident on) through a combiner 109 and a projection optical system 110 to a screen (not illustrated) or the like.

As described above, in the single plate type MEMS mirror type projection system 100D according to the embodiment 13, the control unit 103B corresponds to the control unit 80 in FIG. 4, and synchronization control of a first optical system 50 and a second optical system 70 is performed by the control unit 103B.

### Embodiment 14

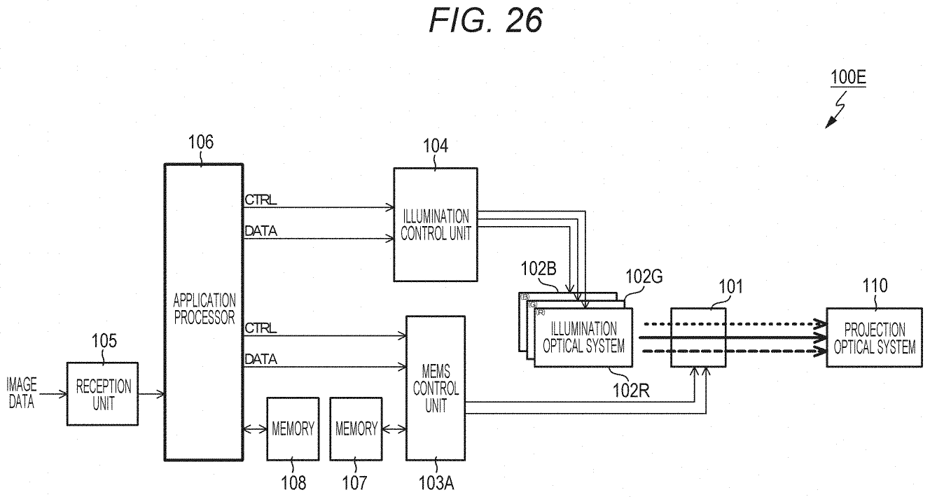

An embodiment 14 is an example of a light source time division type MEMS mirror type projection system and is an example in which an application processor performs synchronization control. One example of a configuration of the MEMS mirror type projection system according to the embodiment 14 is illustrated in FIG. 26.

As illustrated in FIG. 26, a basic system configuration of the light source time division type MEMS mirror type projection system 100E according to the embodiment 14 is the same as that of the single plate type MEMS mirror type projection system 100C according to the embodiment 12. However, the light source time division type MEMS mirror type projection system 100E is different from the single plate type MEMS mirror type projection system 100C in that each of illumination optical systems 102R, 102G, and 102B of R, G, and B is of a light source time division type, that is, RGB light is radiated from illumination optical systems 102R, 102G, and 102B to a light modulation panel 101 in a three-divided manner on a time axis (time division).

In the light source time division type MEMS mirror type projection system 100E according to the embodiment 14, externally inputted image data is supplied via a reception unit 105 to an application processor 106 and is subjected to various kinds of image processing such as gamma correction. The image data which has passed through the application processor 106 is converted into a bit plane format (or PWM) in a MEMS control unit 103A.

Transmission of bit plane data from the MEMS control unit 103A to the light modulation panel 101 is scheduled by the application processor 106 and the bit plane data is transmitted in accordance with a predetermined PWM sequence. At this time, the application processor 106 transmits control data, which corresponds to a luminance level of a bit plane, to the illumination control unit 104.

In synchronization with a PWM sequence in which a bit plane image is displayed on a light modulation panel 101, the illumination control unit 104 controls illumination optical systems 102R, 102G, and 102B of R, G, and B in a time-division manner. MEMS mirrors of the light modulation panel 101, which are illuminated in a time-division manner by the illumination optical systems 102R, 102G, and 102B of R, G, and B, perform on/off operation in accordance with a bit plane. Then, RGB light of pixels in a state in which the MEMS mirrors are turned on is projected (incident on) through a combiner 109 and a projection optical system 110 to a screen (not illustrated) or the like.

As described above, in the light source time division type MEMS mirror type projection system 100E according to the embodiment 14, the application processor 106 corresponds to the control unit 80 in FIG. 4, and synchronization control of a first optical system 50 and a second optical system 70 is performed by the application processor 106.

### Embodiment 15

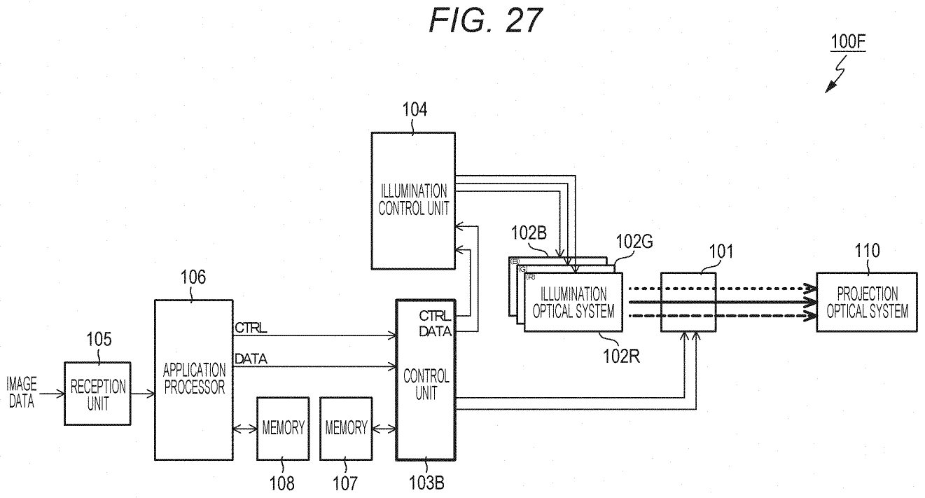

An embodiment 15 is an example of a light source time division type MEMS mirror type projection system and is an example in which a MEMS control unit performs synchronization control. One example of a configuration of the MEMS mirror type projection system according to the embodiment 15 is illustrated in FIG. 27.

A basic system configuration of the light source time division type MEMS mirror type projection system 100F according to the embodiment 15 is the same as that of the light source time division type MEMS mirror type projection system 100E according to the embodiment 14.

However, the light source time division type MEMS mirror type projection system 100F is different from the light source time division type MEMS mirror type projection system 100E in that whereas in the light source time division type MEMS mirror type projection system 100E according to the embodiment 14, the synchronization control of the first optical system 50 and the second optical system 70 is performed by the application processor 106, in the light source time division type MEMS mirror type projection system 100F according to the embodiment 15, the synchronization control thereof is performed by a control unit 103B.

In the light source time division type MEMS mirror type projection system 100F according to the embodiment 15, externally inputted image data is supplied via a reception unit 105 to an application processor 106 and is subjected to various kinds of image processing such as gamma correction. The image data which has passed through the application processor 106 is converted into to a bit plane format (or PWM) in the control unit 103B.

Transmission of bit plane data from the control unit 103B to a light modulation panel 101 is scheduled inside the control unit 103B, and the bit plane data is transmitted in accordance with a predetermined sequence.

At this time, the control unit 103B transmits control data, which corresponds to a luminance level of a bit plane, to an illumination control unit 104.

In synchronization with a PWM sequence in which a bit plane image is displayed on a light modulation panel 101, the illumination control unit 104 controls illumination optical systems 102R, 102G, and 102B of R, G, and B in a time-division manner. MEMS mirrors of the light modulation panel 101, which are illuminated in a time-division manner by the illumination optical systems 102R, 102G, and 102B of R, G, and B, perform on/off operation in accordance with a bit plane. Then, RGB light of pixels in a state in which the MEMS mirrors are turned on is projected (incident on) through a combiner 109 and a projection optical system 110 to a screen (not illustrated) or the like.

As described above, in the light source time division type MEMS mirror type projection system 100F according to the embodiment 15, the control unit 103B corresponds to the control unit 80 in FIG. 4, and synchronization control of a first optical system 50 and a second optical system 70 is performed by the control unit 103B.

### MODIFIED EXAMPLE

Although hereinbefore, on the basis of the preferred embodiments, the technology of the present disclosure is described, the technology of the present disclosure is not limited to the embodiments. The configurations and the structures of the display apparatus and the projection system described in each of the embodiments are illustrative and can be appropriately modified. For example, although in the description of each of the embodiments, the display apparatus or the projection system in which as the light modulation devices, the MEMS mirrors are used is cited as an example, the technology of the present disclosure can be applied to a display apparatus or a projection system in which as each of the light modulation devices, HIPS or LCOS is used.

<A Configurations which the Present Disclosure can Have>

Note that the present disclosure can also have the below-described configuration.

«A. Display Apparatus>>

[A-1] A display apparatus including:

a first optical system which generates illumination light whose light emitting luminance is variable;

a light modulation unit which transmits the illumination light from the first optical system and whose transmissivity is variable;

a second optical system which includes a light modulation device and optically modulates the illumination light from the first optical system by using a pulse width modulation technology, the illumination light having passed through the light modulation unit; and

a control unit which controls the light emitting luminance of the illumination light from the first

optical system and the transmissivity of the light modulation unit in any combination.

[A-2] The display apparatus according to the above-described [A-1], in which

the light modulation device is constituted of an on-state/off-state binary display device.

[A-3] The display apparatus according to the above-described [A-2], in which

the light modulation device is constituted of MEMS mirrors.

[A-4] The display apparatus according to any one of the above-described [A-1] to the above-described [A-3], in which

a light source of the first optical system is constituted of a solid-state light source.

[A-5] The display apparatus according to the above-described [A-4], in which

the solid-state light source is a semiconductor laser, light emitting diodes, or organic light emitting diodes.

[A-6] The display apparatus according to any one of the above-described [A-1] to the above-described [A-5], in which

the light modulation unit is constituted of a variable diaphragm part.

[A-7] The display apparatus according to any one of the above-described [A-4] to the above-described [A-6], in which

the light source of the first optical system is constituted by arranging a plurality of solid-state light sources in an array state, light emitting luminances of the plurality of solid-state light sources being different from one another.

[A-8] The display apparatus according to any one of the above-described [A-4] to the above-described [A-6], in which

the light source of the first optical system is constituted by arranging solid-state light sources whose light emitting luminances are different from one another, each number of the arranged solid-state light sources being in accordance with each required luminance ratio.

[A-9] The display apparatus according to the above-described [A-4], in which

the first optical system is constituted of a combination of fluorescent bodies and a variable light quantity adjusting filter.

[A-10] The display apparatus according to the above-described [A-9], in which

the variable light quantity adjusting filter is an ND filter.

[A-11] The display apparatus according to any one of the above-described [A-1] to the above-described [A-5], in which

the light modulation unit is constituted of a rotary circular ND filter which is rotatable and is constituted by arranging a plurality of ND filters in a circumferential direction, transmissivities of the plurality of ND filters being different from one another.

[A-12] The display apparatus according to any one of the above-described [A-1] to the above-described [A-11], in which

the control unit makes light emitting time as to a least significant bit or bits of low gradations shorter than light emitting time as to other bits, the bits of the low gradation including the least significant bit.

[A-13] The display apparatus according to any one of the above-described [A-1] to the above-described [A-11], in which

the control unit controls a light source luminance of each gradation bit by pulse width modulation. [A-14] The display apparatus according to any one of the above-described [A-6] to the above-described [A-11], in which

the control unit changes a combination of a light emitting luminance of a solid-state light source and a stop of the variable diaphragm part in accordance with a video source.

[A-15] The display apparatus according to the above-described [A-14], in which

the video source is a sport, a variety show, an animation, or a movie.

[A-16] The display apparatus according to any one of the above-described [A-1] to the above-described [A-11], in which

the control unit makes bit arrangement of a first frame and bit arrangement of a second frame inverse to each other with respect to a boundary between the frames in a sequence with the first frame and the second frame as one set.

### <<B. Projection System>>

[B-1] A projection system including:

a first optical system which generates illumination light whose light emitting luminance is variable;

a light modulation unit which transmits the illumination light from the first optical system and whose transmissivity is variable;

a second optical system which includes a light modulation device and optically modulates the illumination light from the first optical system by using a pulse width modulation technology, the illumination light having passed through the light modulation unit;

a projection optical system which projects light having passed through the second optical system; and

a control unit which controls the light emitting luminance of the illumination light from the first optical system and the transmissivity of the light modulation unit in any combination.

[B-2] The projection system according to the above-described [B-1], in which

the light modulation device is constituted of an on-state/off-state binary display device.

[B-3] The projection system according to the above-described [B-2], in which

the light modulation device is constituted of MEMS mirrors.

[B-4] The projection system according to any one of the above-described [B-1] to the above-described [B-3], in which

the first optical system is constituted of a solid-state light source.

[B-5] The projection system according to the above-described [B-4], in which

the solid-state light source is a semiconductor laser, light emitting diodes, or organic light emitting diodes.

[B-6] The projection system according to any one of the above-described [B-1] to the above-described [B-5], in which

the light modulation unit is constituted of a variable diaphragm part.

[B-7] The projection system according to any one of the above-described [B-4] to the above-described [B-6], in which

the light source of the first optical system is constituted by arranging a plurality of solid-state light sources in an array state, light emitting luminances of the plurality of solid-state light sources being different from one another.

[B-8] The projection system according to any one of the above-described [B-4] to the above-described [B-6], in which

the light source of the first optical system is constituted by arranging solid-state light sources whose light emitting luminances are different from one another, each number of the arranged solid-state light sources being in accordance with each required luminance ratio.

[B-9] The projection system according to the above-described [B-4], in which

the first optical system is constituted of a combination of fluorescent bodies and a variable light quantity adjusting filter.

[B-10] The projection system according to the above-described [B-9], in which

the variable light quantity adjusting filter is an ND filter.

[B-11] The projection system according to any one of the above-described [B-1] to the above-described [B-5], in which

the light modulation unit is constituted of a rotary circular ND filter which is rotatable and is constituted by arranging a plurality of ND filters in a circumferential direction, transmissivities of the plurality of ND filters being different from one another. [B-12] The projection system according to any one of the above-described [B-1] to the above-described [B-11], in which

the control unit makes light emitting time as to a least significant bit or bits of low gradations shorter than light emitting time as to other bits, the bits of the low gradation including the least significant bit. [B-13] The projection system according to any one of the above-described [B-1] to the above-described [B-11], in which

the control unit controls a light source luminance of each gradation bit by pulse width modulation. [B-14] The projection system according to any one of the above-described [B-6] to the above-described [B-11], in which

the control unit changes a combination of a light emitting luminance of a solid-state light source and a stop of the variable diaphragm part in accordance with a video source.

[B-15] The projection system according to the above-described [B-14], in which

the video source is a sport, a variety show, an animation, or a movie.

[B-16] The projection system according to any one of the above-described [B-1] to the above-described [B-11], in which

the control unit makes bit arrangement of a first frame and bit arrangement of a second frame inverse to each other with respect to a boundary between the frames in a sequence with the first frame and the second frame as one set.

### REFERENCE SIGNS LIST

10 Projection system
11R, 11G, 11B Solid-state light source
13, 14 Dichroic mirror
16 Rod integrator
19 Total reflection prism
20 Display panel
21 Projection lens
30 Screen
40 Display apparatus
50 First optical system
51 Solid-state light source
52 Luminance control unit
53 ND filter
60 Light modulation unit
61 Light modulation element
62 Transmissivity control unit
63 Variable diaphragm part
64 Rod integrator
65 Rotary circular ND filter
66 Rotation angle control unit
70 Second optical system
71 Light modulation element
72 Modulation control unit
80 Control unit
81 Look-up table
100A to 100F Projection system
101 Light modulation panel
101R, 101G, 101B Light modulation panels of R (red color), G (green color), and B (blue color)
102R, 102G, 102B Illumination optical system
103A MEMS control unit
103 Control unit
106 Application processor
110 Projection optical system

1. A display apparatus comprising:
a first optical system that generates illumination light whose light emitting luminance is variable;
a light modulation unit that transmits the illumination light from the first optical system and whose transmissivity is variable;
a second optical system that includes a light modulation device and optically modulates the illumination light from the first optical system by using a pulse width modulation technology, the illumination light having passed through the light modulation unit; and
a control unit that controls the light emitting luminance of the illumination light from the first optical system and the transmissivity of the light modulation unit in any combination.

2. The display apparatus according to claim 1, wherein
the light modulation device is constituted of an on-state/off-state binary display device.

3. The display apparatus according to claim 2, wherein
the light modulation device is constituted of MEMS mirrors.

4. The display apparatus according to claim 1, wherein
a light source of the first optical system is constituted of a solid-state light source.

5. The display apparatus according to claim 4, wherein
the solid-state light source is a semiconductor laser, light emitting diodes, or organic light emitting diodes.

6. The display apparatus according to claim 1, wherein
the light modulation unit is constituted of a variable diaphragm part.

7. The display apparatus according to claim 4, wherein
the light source of the first optical system is constituted by arranging a plurality of solid-state light sources in an array state, light emitting luminances of the plurality of solid-state light sources being different from one another.

8. The display apparatus according to claim 4, wherein
the light source of the first optical system is constituted by arranging solid-state light sources whose light emitting luminances are different from one another, each number of the arranged solid-state light sources being in accordance with each required luminance ratio.

9. The display apparatus according to claim 4, wherein
the first optical system is constituted of a combination of fluorescent bodies and a variable light quantity adjusting filter.

10. The display apparatus according to claim 9, wherein
the variable light quantity adjusting filter is an ND filter.

11. The display apparatus according to claim 1, wherein
the light modulation unit is constituted of a rotary circular ND filter that is rotatable and is constituted by arranging a plurality of ND filters in a circumferential direction, transmissivities of the plurality of ND filters being different from one another.

12. The display apparatus according to claim 1, wherein
the control unit makes light emitting time as to a least significant bit or bits of low gradations shorter than light emitting time as to other bits, the bits of the low gradation including the least significant bit.

13. The display apparatus according to claim 1, wherein
the control unit controls a light source luminance of each gradation bit by pulse width modulation.

14. The display apparatus according to claim 6, wherein
the control unit changes a combination of a light emitting luminance of a solid-state light source and a stop of the variable diaphragm part in accordance with a video source.

15. The display apparatus according to claim 14, wherein
the video source is a sport, a variety show, an animation, or a movie.

16. The display apparatus according to claim 1, wherein
the control unit makes bit arrangement of a first frame and bit arrangement of a second frame inverse to each other with respect to a boundary between the frames in a sequence with the first frame and the second frame as one set.

17. A projection system comprising:
a first optical system that generates illumination light whose light emitting luminance is variable;
a light modulation unit that transmits the illumination light from the first optical system and whose transmissivity is variable;
a second optical system that includes a light modulation device and optically modulates the illumination light from the first optical system by using a pulse width modulation technology, the illumination light having passed through the light modulation unit;
a projection optical system that projects light having passed through the second optical system; and
a control unit that controls the light emitting luminance of the illumination light from the first optical system and the transmissivity of the light modulation unit in any combination.

18. The projection system according to claim 17, wherein
the light modulation device is constituted of an on-state/off-state binary display device.

19. The projection system according to claim 18, wherein
the light modulation device is constituted of MEMS mirrors.

20. The projection system according to claim 17, wherein
the first optical system has a solid-state light source.
